(19) United States
(12) Patent Application Publication
(10) Pub. No.: US 2026/0202915 A1
(43) Pub. Date: Jul. 16, 2026

(54) SYSTEMS AND METHODS FOR DUAL-PATH NEURAL SIGNAL PROCESSING FOR BRAIN-COMPUTER INTERFACES

(71) Applicant: Homatch.ai, Milipitas, CA (US)

(72) Inventor: Mingjun Wang, Saratoga, CA (US)

(21) Appl. No.: 19/449,258

(22) Filed: Jan. 14, 2026

Related U.S. Application Data
(60) Provisional application No. 63/746,016, filed on Jan. 16, 2025.
(60) Provisional application No. 63/746,176, filed on Jan. 16, 2025.

(51) Int. Cl. G06F 3/01; G06F 3/14

(52) U.S. Cl. CPC G06F 3/015; G06F 3/1454

(57) ABSTRACT

A system may include a brainwave recorder and a processor. The brainwave recorder may capture brainwave signals of an operator associated with an external device (ED). The processor may segment the brainwave signals into high-frequency (HF) signals and low-frequency (LF) signals. The processor may include a dual-path arrangement that includes first and second paths. The first path may generate command data related to control of the ED based on the HF signals. The second path may generate state data related to a state of the operator based on the LF signals. The processor may generate a command set for the ED based on the command and state data. The command set may include a sequence of actions to be performed by the ED. The processor may cause the command set to be transmitted to the ED to cause the ED to perform the actions, which may be executed autonomously.

### RELATED APPLICATION

This application claims the benefit of and priority to U.S. Provisional Application No. 63/746,016 filed Jan. 16, 2025, and to U.S. Provisional Application No. 63/746,176 filed Jan. 16, 2025, the entire contents of both provisional applications are hereby incorporated by reference in their entirety.

### TECHNICAL FIELD

The present disclosure relates to systems and methods for dual-path neural signal processing for brain-computer interfaces.

### BACKGROUND

Unless otherwise indicated herein, the materials described herein are not prior art to the claims in the present application and are not admitted to be prior art by inclusion in this section.

A brain-computer interface (BCI) system enables brainwave signals (e.g., neural activity) of a person to be captured to allow direct communication between a brain (e.g., the brainwave signals) of the person and an external device. The BCI system operates by acquiring, interpreting, and translating the brainwave signals. The BCI system may record the brainwave signals using a variety of sensing modalities, including non-invasive techniques such as electroencephalography (EEG), magnetoencephalography (MEG), or functional near-infrared spectroscopy (fNIRS), as well as invasive or semi-invasive techniques such as electrocorticography (ECoG) or microelectrode arrays capable of detecting neuronal spikes.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION

The present application can be best understood by reference to the embodiments described below taken in conjunction with the accompanying drawing figures, in which like parts may be referred to by like numerals.

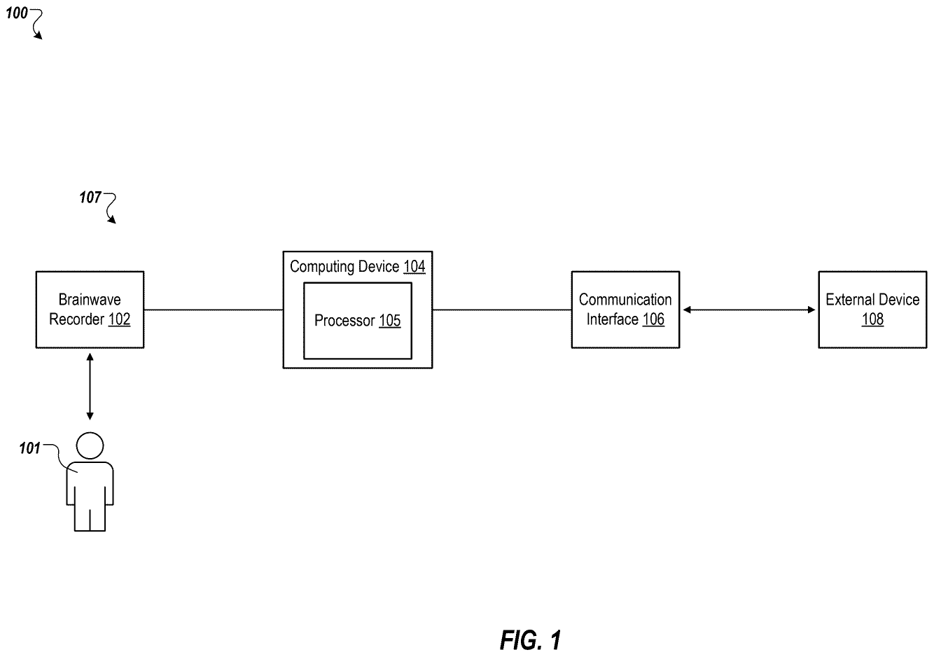

FIG. 1 illustrates a block diagram of an example operational environment for using a BCI system, in accordance with examples as disclosed herein.

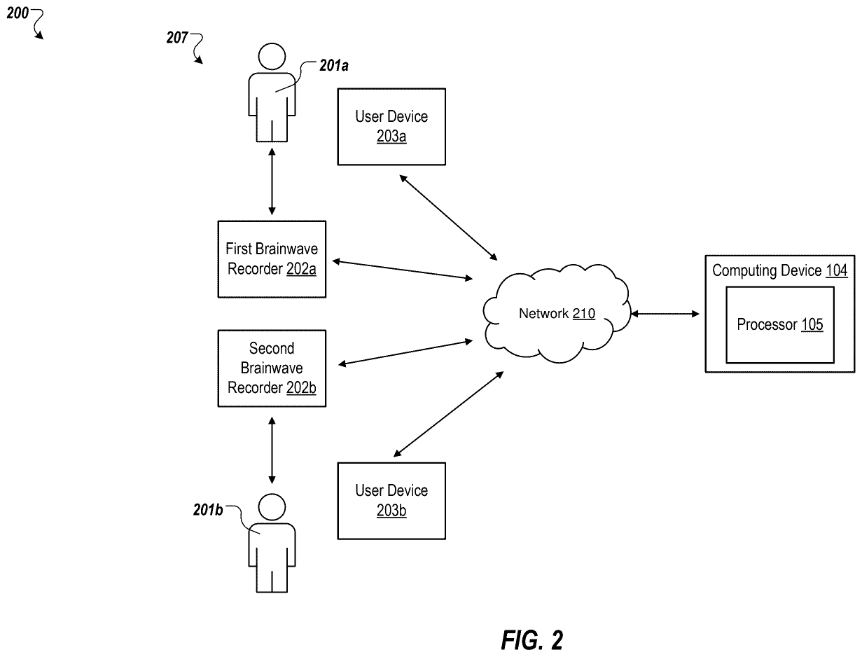

FIG. 2 illustrates a block diagram of an example operational environment for using a BCI system, in accordance with examples as disclosed herein.

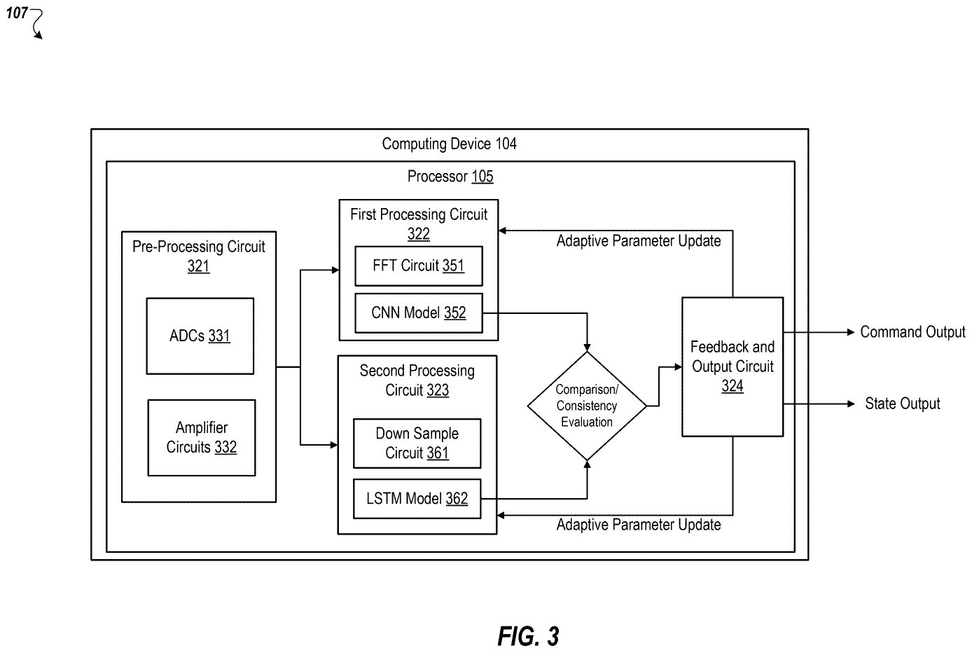

FIG. 3 illustrates a block diagram of an example of the BCI systems of FIGS. 1 and 2, in accordance with examples as disclosed herein.

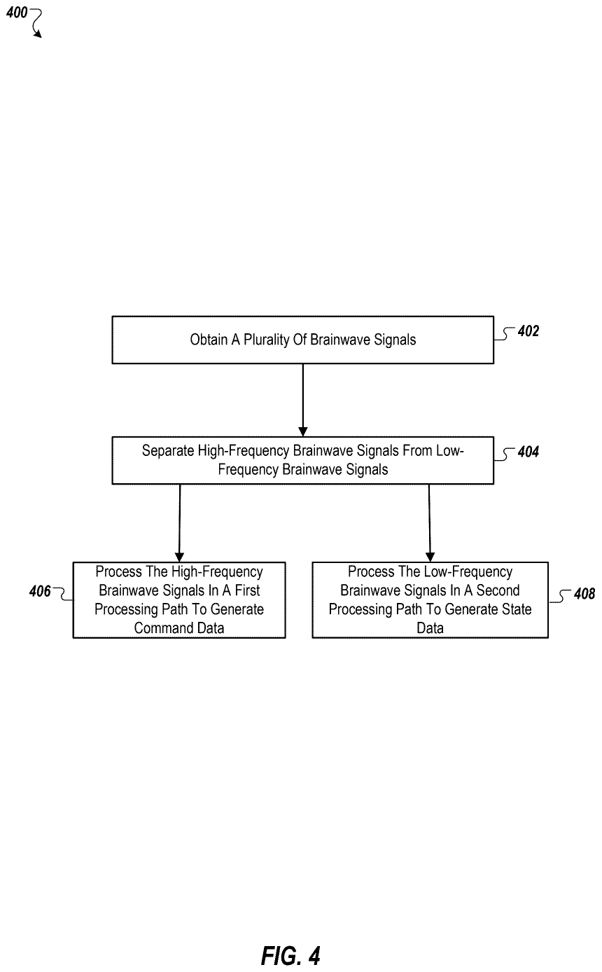

FIG. 4 illustrates a flowchart showing a method for processing brainwave signals of an operator, in accordance with examples as disclosed herein.

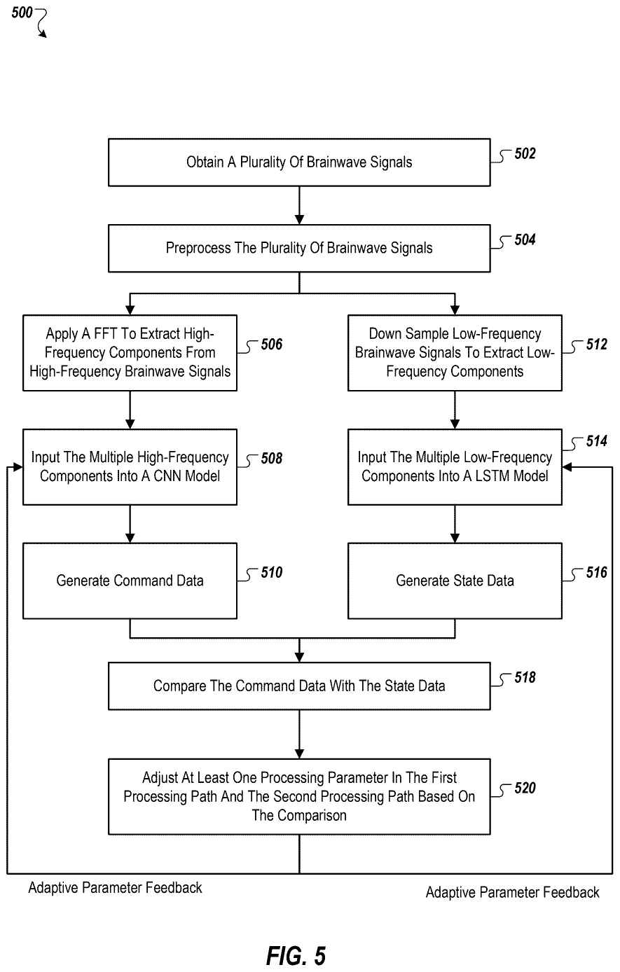

FIG. 5 illustrates a flowchart showing another method to process brainwave signals in accordance with examples as disclosed herein.

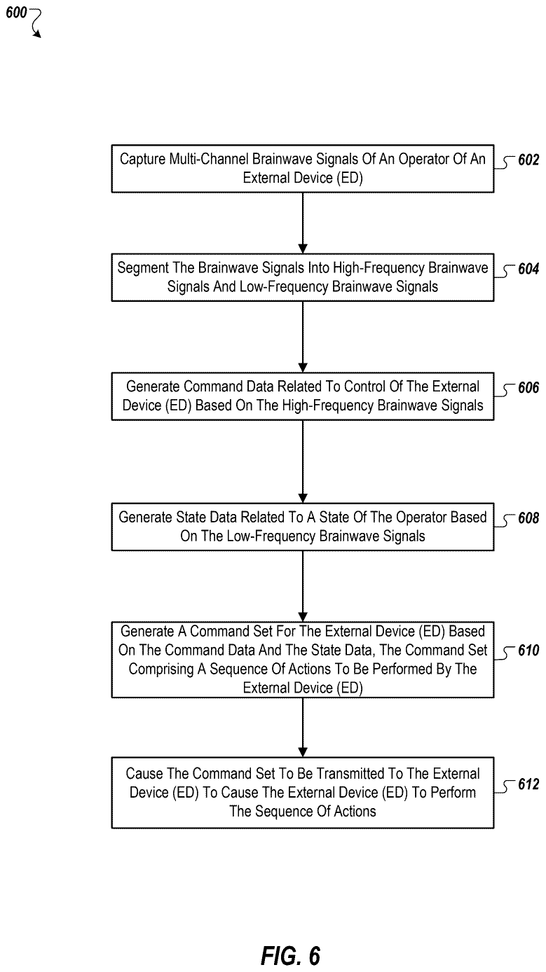

FIG. 6 depicts a flowchart of a method for causing an external device to perform a sequence of actions based on brainwave signals, in accordance with at least one embodiment described herein.

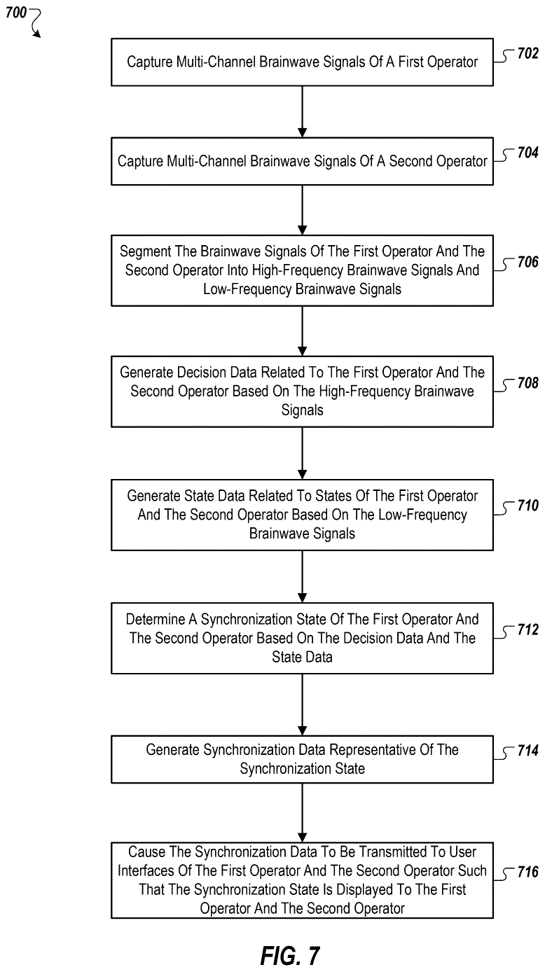

FIG. 7 depicts a flowchart of a method for determining and displaying a synchronization state of a first operator and a second operator, in accordance with examples as disclosed herein.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a system may include a brainwave recorder configured to capture multi-channel brainwave signals an operator associated with an external device (ED). In some embodiments, the external device includes an unmanned aerial vehicle (UAV). In other embodiments, the external device may include a robotic device, a prosthetic limb, a mobility-assist device, a computer cursor, a typing or selection interface, a virtual-reality or augmented-reality system, an industrial robot, or any other controllable system capable of executing actions based on command data. In embodiments in which the external device includes a UAV, the feedback may include navigation data, altitude information, stability metrics, or other flight-related parameters. Such embodiments are illustrative and do not limit the scope of the present disclosure. The system may include a processor configured to segment the brainwave signals into high-frequency (HF) brainwave signals and low-frequency (LF) brainwave signals. The processor may include a dual-path processing arrangement that includes a first processing path configured to generate command data related to control of the external device (ED) based on the HF brainwave signals. The dual-path processing arrangement may also include a second processing path configured to generate state data related to a state of the operator based on the LF brainwave signals. The processor may generate a command set for the external device (ED) based on the command data and the state data, the command set including a sequence of actions to be performed by the external device (ED). The processor may cause the command set to be transmitted to the external device (ED) to cause the external device (ED) to perform the sequence of actions, at least a portion of which may be executed autonomously.

In another example embodiment, a method may include capturing multi-channel brainwave signals of an operator associated with an external device (ED). The method may include segmenting the brainwave signals into HF brainwave signals and LF brainwave signals. The method may include generating command data related to control of the external device (ED) based on the HF brainwave signals. The method may include generating state data related to a state of the operator based on the LF brainwave signals. The method may include generating a command set for the external device (ED) based on the command data and the state data, the command set including a sequence of actions to be performed by the external device (ED). The method may include causing the command set to be transmitted to the external device (ED) to cause the external device (ED) to perform the sequence of actions, at least a portion of which may be executed autonomously.

In yet another example embodiment, a system may include a first brainwave recorder configured to capture multi-channel brainwave signals of a first operator. The system may include a second brainwave recorder configured to capture multi-channel brainwave signals of a second operator. The system may include a processor configured to segment the brainwave signals of the first operator and the second operator into HF brainwave signals and LF brainwave signals. The processor may include a dual-path processing arrangement including a first processing path configured to generate decision data related to the first operator and the second operator based on the HF brainwave signals. The processor may include a second processing path configured to generate state data related to states of the first operator and the second operator based on the LF brainwave signals. The processor may determine a synchronization state of the first operator and the second operator based on the decision data and the state data, wherein the synchronization state may indicate an amount of synchronization between the brainwave signals of the first operator and the second operator. The processor may generate synchronization data representative of the synchronization state. The processor may cause the synchronization data to be transmitted to user interfaces of the first operator and the second operator such that the synchronization state may be displayed to the first operator and the second operator.

In another example embodiment, a method may include capturing multi-channel brainwave signals of a first operator. The method may also include capturing multi-channel brainwave signals of a second operator. In addition, the method may include segmenting the brainwave signals of the first operator and the second operator into HF brainwave signals and LF brainwave signals. Further, the method may include generating decision data related to the first operator and the second operator based on the HF brainwave signals. The method may include generating state data related to states of the first operator and the second operator based on the LF brainwave signals. The method may also include determining a synchronization state of the first operator and the second operator based on the decision data and the state data. The synchronization state may indicate an amount of synchronization between the brainwave signals of the first operator and the second operator. In addition, the method may include generating synchronization data representative of the synchronization state. Further, the method may include causing the synchronization data to be transmitted to user interfaces of the first operator and the second operator such that the synchronization state is displayed to the first operator and the second operator.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

An external device (ED) may perform sequences of actions based on a command set. For example, the external device may perform navigation actions, task execution operations, data acquisition operations, or other context-dependent actions based on the command set. The external device (ED) is generally described in the present disclosure as an external device (ED). However, the external device (ED) may include any appropriate device that can be controlled based on the command set. For example, the external device (ED) may include a robot, a prosthetic limb, a wheelchair, a mobility-assist robot, a computer cursor, a computer typing interface, a virtual-reality (VR) or augmented-reality (AR) system, a neurostimulator used for therapeutic modulation, an unmanned vehicle (e.g., car, scooter, or motorcycle), a UAV, or any other appropriate external device.

Some external devices implement manual control of the external devices in which the command set is generated based on manual input provided by the operator. For example, the operator may manipulate or move a joystick or other remote control at a command terminal. However, the operator manipulating or moving the remote control at the command terminal may be cumbersome, result in delayed or slowed adapting to changes in operational parameters, or may be prone to operator fatigue.

A BCI system may generate the command set based on the brainwave signals to permit direct command of the external device (ED) using the brainwave signals of the operator. The BCI system may be less cumbersome than manual control of the external device (ED). In addition, the BCI system may adapt to changes in operational parameters more quickly or faster compared to the manual control of the external device (ED).

However, some BCI systems may include low processing efficiency, weak multi-task adaptability, or limited robustness. For example, these BCI systems may decode the brainwave signals at low speeds, with low accuracy, or both. As another example, these BCI systems may not be able to support multi-dimensional brainwave signals. For example, brainwave signals may exhibit variations in frequency, amplitude, energy distribution, or spatiotemporal structure, which may cause the brainwave signals to change over time, for different cognitive states of the operator, or for different operators. As yet another example, these BCI systems may be impacted by external interference (e.g., noise, electromagnetic fields, or other interference). These issues or aspects of these BCI systems hinder or prevent safe or reliable control of the external device (ED) based on brainwave signals.

The present disclosure provides techniques for avoiding or reducing the technical difficulties described above. Some embodiments described herein include a brain-computer interface (BCI) system (generally referred to as “the system”) that permits safe and reliable control of an external device (ED) based on brainwave signals. The system includes a dual-path processing arrangement (e.g., a double-helix processing structure) that separately processes low-frequency (LF) brainwave signals and high-frequency (HF) brainwave signals.

As used in the present disclosure, LF brainwave signals generally include neural signal components associated with relatively slower neural dynamics and longer-term or global brain states, while HF brainwave signals generally include neural signal components associated with relatively faster neural dynamics and short-term or localized neural activity. By way of example, LF brainwave signals may include delta waves (approximately 0.5-4 Hz), theta waves (approximately 4-8 Hz), alpha waves (approximately 8-13 Hz), or combinations thereof. HF brainwave signals may include beta waves (approximately 13-30 Hz), gamma waves (approximately 30-100 Hz or higher), or combinations thereof.

In some embodiments, the boundary between LF and HF brainwave signals may be approximately thirty hertz (Hz). In other embodiments, the boundary frequency may be configurable and may range from approximately thirteen hertz (Hz) to approximately forty hertz (Hz), depending on sensing modality, noise conditions, system configuration, or application requirements. Accordingly, in example embodiments, LF brainwave signals may include frequencies below approximately thirty hertz (Hz), and HF brainwave signals may include frequencies above approximately thirty hertz (Hz), with the frequency boundary being selectable or adjustable based on operational context. The frequency boundary separating HF brainwave signals and LF brainwave signals may be dynamically adjustable or selected from a configurable range to accommodate different recording techniques, operators, or environmental conditions.

The system receives (e.g., acquires) the brainwave signals through invasive or non-invasive devices such as EEG, ECOG, MEG, fNIRS, intracortical microelectrodes, or other neural recording techniques. The system may process the brainwave signals to extract features associated with a state, motor intentions, sensory response, or any other appropriate mental aspect of the operator. In addition, the system may translate the extracted features into a command set that is sent to the external device (ED) to cause the external device (ED) to perform a sequence of actions corresponding to the command set. Further, the system may generate feedback based on the extracted features to adjust processing parameters of the system to account for changes in operational parameters, the state of the operator, or any other appropriate aspect. In some embodiments, the system is configured to adaptively modify one or more signal processing parameters of the first processing path and the second processing path based on a comparison between the command data and the state data. Such adaptive modification may include adjusting frequency thresholds, confidence thresholds, model weights, gating coefficients, or fusion weights to improve alignment between short-term neural intent and longer-term cognitive state.

In one example, a system may include a brainwave recorder and a processor. The brainwave recorder may capture multi-channel brainwave signals of the operator. The processor may segment the brainwave signals into HF brainwave signals and LF brainwave signals. The processor may include the dual-path processing arrangement that includes a first processing path and a second processing path. The first processing path may generate command data related to control of the external device (ED) based on the HF brainwave signals. The second processing path may generate state data related to a state of the operator based on the LF brainwave signals.

The processor may generate a command set for the external device (ED) based on the command data and the state data. The command set may include a sequence of actions to be performed by the external device (ED). In addition, the processor may cause the command set to be transmitted to the external device (ED) to cause the external device (ED) to perform the sequence of actions, at least a portion of which may be executed autonomously.

As described briefly above and in more detail below, the systems described in the present disclosure improve accuracy, efficiency, responsiveness, or reliability of the command set generated based on the brainwave signals. In particular, the dual-path processing arrangement of the systems increases the signal efficiency, the multi-task adaptability, the environmental robustness, or some combination thereof of the system for use with the external device (ED) (or any appropriate external device). In addition, the system provides feedback to dynamically refine the operations of the system to increase accuracy of the command set.

A BCI system may facilitate interactions involving multiple operators (e.g., people or users) through synchronized brainwave processing. The BCI system may capture and analyze brainwave signals from multiple operators simultaneously, enabling collaborative control scenarios or shared cognitive experiences. For example, a teacher and a student may use the BCI system during lessons to enable a shared cognitive experience to detect engagement of the student. As another example, two or more operators may jointly control an external device (ED) in a coordinated manner using the BCI system.

The BCI system may be implemented in various environments such as a healthcare facility for medical collaboration, a school for educational instruction, general environments for a cooperative task or group entertainment such as multiple operator gaming or AR or VR.

Some BCI systems may encounter substantial difficulties when synchronizing brainwave signals between multiple operators. The different operators may exhibit unique timing or parameters in corresponding brainwave signals. The variations in the brainwave signals of the different operators may vary over short periods of time, long periods of time, or both. As a result, alignment of the brainwave signals across the different operators may create poor coherence or synchronization. This desynchronization may cause mismatches between inferred cognitive states, degraded estimation of joint intent, communication, or inconsistent detection of shared events between the different operators.

Some BCI systems may experience latency when acquiring, processing, or transmitting the brainwave signals between multiple operators. These BCI systems may introduce or cause delays at different stages due to processing limitations. These BCI systems may exhibit low data transmission efficiency when handling high-dimensional or multi-channel brainwave signals from the multiple operators. The brainwave signals may create large volumes of data, which may overload processing power of these BCI systems. These delays may reduce responsiveness of the interactions between or degrade shared experiences between the multiple operators.

Some embodiments disclosed herein may address one or more of the challenges of these BCI systems, such as difficulties when synchronizing brainwave signals, latency, or processing delays. For example, one or more embodiments herein may overcome one or more of the foregoing challenges by leveraging a dual-path processing arrangement (e.g., double-helix processing structure) that separately processes LF brainwave signals and HF brainwave signals of the operators. The dual-path processing arrangement may allow parallel computations to be performed.

At least one embodiment described in the present disclosure may include a BCI system (generally referred to in the present disclosure as “the system”) that is configured to facilitate interaction between multiple operators. The system may include multiple brainwave recorders that separately capture brainwave signals of the operators. The system includes a processor that segments the brainwave signals of the operators into HF brainwave signals and LF brainwave signals. The processor may include a first processing circuit (e.g., a local path) and a second processing circuit (e.g., a global path) that form the dual-path processing arrangement. The first processing circuit may process the HF brainwave signals to generate decision data for the operators. The second processing circuit may process the LF brainwave signals to generate state data for the operators. The processor may compare the decision data and the state data to determine a synchronization state of the operators. The processor may adjust processing parameters of the first processing circuit, the second processing circuit, or both based on feedback related to the comparison of the decision data and the state data, the decision data itself, the state data itself, or some combination thereof. The first processing circuit may implement different protocols for processing the HF brainwave signals than the protocols implemented by the second processing circuit for processing the LF brainwave signals.

In one example, a system may include a first brainwave decoder, a second brainwave decoder, and a processor. The first brainwave recorder may capture multi-channel brainwave signals of a first operator. The second brainwave recorder may capture multi-channel brainwave signals of a second operator. The processor may segment the brainwave signals of the first operator and the second operator into HF brainwave signals and LF brainwave signals. The processor may include a dual-path processing arrangement that includes a first processing path and a second processing path. The first processing path may generate decision data related to the first operator and the second operator based on the HF brainwave signals. The second processing path may generate state data related to states of the first operator and the second operator based on the LF brainwave signals.

The processor may determine a synchronization state of the first operator and the second operator based on the decision data and the state data. The synchronization state may indicate an amount of synchronization between the brainwave signals of the first operator and the second operator. The processor may also generate synchronization data representative of the synchronization state. In addition, the processor may cause the synchronization data to be transmitted to user interfaces of the first operator and the second operator such that the synchronization state is displayed to the first operator and the second operator.

As described briefly above and in more detail below, the system described in the present disclosure enable real-time synchronization or data sharing between the multiple operators. In addition, the system described in the present disclosure may facilitate efficient collaborative control or shared cognitive experiences between the multiple operators.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

FIG. 1 illustrates a block diagram of an example operational environment 100 for using a BCI system 107, in accordance with at least one embodiment described herein. As shown in FIG. 1, the environment 100 includes an operator 101, the BCI system 107, a communication interface 106, and an external device 108. In some embodiments, the external device 108 may include a UAV. The BCI system 107 may include a brainwave recorder 102 and a computing device 104. The computing device 104 may include a processor 105.

The operator 101 may wear or otherwise be connected to the brainwave recorder 102. The brainwave recorder 102 may be communicatively coupled to the computing device 104 including the processor 105. The computing device 104 may be communicatively coupled to the antenna 106. The antenna 106 may transmit signals to and receive signals from the external device (ED) 108.

In some embodiments, the computing device 104, the brainwave recorder 102, or the antenna 106 may be co-located in a single housing. For example, the computing device 104 and the brainwave recorder 102 may be co-located in a single housing. As another example, the computing device 104, the brainwave recorder 102, and the antenna 106 may be co-located. Alternatively, the computing device 104, the brainwave recorder 102, or the antenna 106 may be located remotely (e.g., in separate housings). For example, the computing device 104 and the antenna 106 may be co-located in a single housing and the brainwave recorder 102 may be located remotely. As another example, each of the computing device 104, the brainwave recorder 102, and the antenna 106 may be located remotely and in separate housings.

The brainwave recorder 102 may include a wearable or implantable device configured to capture multi-channel brainwave signals of the operator 101. In some embodiments, the brainwave recorder 102 may include multiple electrodes positioned according to the international 10-20 system to ensure comprehensive coverage of the cerebral cortex. Alternatively, the brainwave recorder 102 may include intracortical microelectrodes or ECoG arrays that may be surgically placed to directly interface with neural tissue for enhanced signal quality and spatial resolution.

The brainwave recorder 102 may capture a wide spectrum of brainwave signals across multiple frequency bands. The brainwave signals may include multiple HF components and multiple LF components. These frequencies may include delta waves (0.5-4 Hz) associated with deep sleep and unconscious processes, theta waves (4-8 Hz), alpha waves (8-13 Hz), beta waves (13-30 Hz), and gamma waves (30-100 Hz or higher). The theta waves may represent certain memory functions of the operator 101. The delta waves may represent unconscious processes of the operator 101. The beta waves may represent active thinking or focus of the operator 101. The gamma waves may represent higher cognitive functions or information processing of the operator 101.

The brainwave recorder 102 may capture the brainwave signals at rates of up to five hundred twelve Hz to ensure adequate temporal resolution for capturing the full range of neural oscillations. The brainwave recorder 102 may capture the brainwave signals using two or more different channels (e.g., sixteen channels or one hundred twenty eight channels).

The brainwave recorder 102 may include noise reduction or artifact removal capabilities to enhance quality of the captured brainwave signals. The brainwave recorder 102 may include active shielding against electromagnetic interference, adaptive filtering algorithms to remove muscle artifacts or eye movements, or real-time impedance monitoring based on electrode contact. The brainwave recorder 102 may include wireless transmission capabilities to send the captured brainwave signals to the computing device 104 for processing.

The computing device 104 may include a general-purpose computer, a specialized computer, a mobile device, a personal digital assistant (PDA), a cell phone, a tablet, a laptop, a set-top box, a wearable device, a brain-computer interface device, or any other processor-enabled device that may store, retrieve, and process data. The computing device 104 may include the processor 105, a memory (not shown), a user interface (not shown), a display (not shown), or a communication interface (not shown).

The processor 105 may include one or more general-purpose processors, application-specific integrated circuits (ASICs), field-programmable gate arrays (FPGAs), digital signal processors (DSPs), central processing units (CPUs), microprocessors (μPs), or other integrated formats. The processor 105 may execute computer instructions to perform or control performance of one or more of the operations described herein. The processor 105 may be implemented using a combination of hardware and software. The processor 105 may be configured to implement various algorithms, including signal processing algorithms, machine learning algorithms, neural network algorithms, and other algorithms suitable for processing brainwave signals. In the present disclosure, operations described as being performed by the processor 105 or the computing device 104 may include operations that the processor 105 or the computing device 104 directs a corresponding system to perform.

The computing device 104 may be communicatively coupled to the brainwave recorder 102. The computing device 104 may receive the brainwave signals from the brainwave recorder 102. As described in more detail below, the processor 105 may segment the brainwave signals into HF brainwave signals and LF brainwave signals.

As described in more detail below, the processor 105 may include a dual-path processing arrangement to process the HF brainwave signals and the LF brainwave signals separately. The processor 105 may process the brainwave signals to extract features associated with a state, motor intentions, sensory response, or any other appropriate mental aspect of the operator 101.

A first processing circuit (such as first processing circuit 322 of FIG. 3) (e.g., a first processing path) of the processor 105 may generate command data related to control of the external device (ED) 108 based on the HF brainwave signals. The first processing circuit may also be called a local path. The first processing circuit may process the HF brainwave signals for actions for the external device (ED) 108. The actions may include ascend, descend, rotate left, rotate right, move forward, move backward, hover, accelerate, decelerate, capture image, return home, land, takeoff, abort mission, or any other appropriate action.

A second processing circuit (such as second processing circuit 323 of FIG. 3) (e.g., a second processing path) of the processor 105 may generate state data related to a state of the operator 101 based on the LF brainwave signals. The second processing circuit may also be called a global path. The second processing circuit may process the LF brainwave signals for aspects related to a cognitive state of the operator 101. The aspects related to the cognitive state of the operator may include attention level, mental workload, fatigue, stress, emotional state, focus, alertness, cognitive load, decision confidence, task engagement, situational awareness, anxiety, relaxation, confusion, frustration, concentration, mental readiness, cognitive flexibility, processing capacity, or any other appropriate aspect.

The processor 105 may generate a command set for the external device (ED) 108 based on the brainwave signals. In particular, the processor 105 may generate the command set based on the command data, the state data, or both. The command set may include a sequence of actions to be performed by the external device (ED) 108. The processor 105 may merge the command data and the state data to generate the command set as a single coherent set of actions.

The processor 105 may cause the command set to be transmitted to the external device (ED) 108 via the antenna 106. The antenna 106 may transmit the command set to the external device (ED) 108 using a low-latency data link. The antenna 106 may include a high-speed wireless transmitter that may operate using one or more communication protocols such as LoRa, Wi-Fi, 5G, or other appropriate wireless communication technologies. The antenna 106 may be designed with appropriate shielding and signal amplification to ensure reliable transmission of the command set even in environments with potential electromagnetic interference or noise. The antenna 106 may prioritize the transmission of time-critical command signals to minimize latency and ensure responsive control of the external device (ED) 108.

The command set may cause the external device (ED) 108 to perform the sequence of actions, at least a portion of which may be executed autonomously. An autopilot of the external device (ED) 108 may receive and execute the tasks in the command set.

The processor 105 may receive feedback from the external device (ED) 108 to adjust processing parameters based on the feedback to improve the accuracy and reliability of the command set generation. The low-latency data link between the antenna 106 and the external device (ED) 108 may form a bidirectional link, allowing the antenna 106 to receive telemetry and status information from the external device (ED) 108 while transmitting the command set. For example, the external device (ED) 108 may provide global positioning system information, internal measurement unit information, obstacle detection, or any other appropriate information.

The processor 105 may adjust subsequent command sets by adjusting processing parameters based on the feedback from the external device (ED) 108, thereby creating a closed-loop control system that may continuously control operation of the external device (ED) 108 based on both the brainwave signals of the operator 101 and operational parameters of the external device (ED) 108.

FIG. 3 illustrates a block diagram of an example of the BCI system 107 of FIG. 1, in accordance with at least one embodiment described in the present disclosure. As shown in FIG. 3, the processor 105 may include a pre-processing circuit 321, the first processing circuit 322, the second processing circuit 323, or a feedback and output circuit 324.

The processor 105 may load the dual-path processing arrangement of the first and second processing circuits 322, 323 through a systematic initialization and configuration process. During system startup, the processor 105 may allocate computational resources to both the first processing circuit 322 and the second processing circuit 323, establishing the dual-path processing arrangement for parallel processing of the brainwave signals.

The processor 105 may configure the first processing circuit 322 with appropriate parameters for processing the HF brainwave signals, including loading a fast Fourier transform (FFT) circuit 351 with transformation coefficients and initializing a convolutional neural network (CNN) model 352 with pre-trained weights and biases optimized for detecting immediate control commands. These parameters may be retrieved from non-volatile memory and loaded into active processing registers to enable real-time signal analysis of the HF components. In one example implementation, the first processing path may employ a convolutional neural network (CNN) architecture configured as described below. Other CNN architectures, including architectures with different numbers of layers, channels, kernel sizes, or activation functions, may also be used without departing from the scope of the present disclosure.

The processor 105 may initialize the second processing circuit 323 by configuring a down sample circuit 361 with appropriate sampling rates and filter coefficients. In addition, the processor 105 may load a long short-term memory (LSTM) model 362 with pre-trained model parameters to track cognitive states of the operator 101 based on the LF brainwave signals. In one example implementation, the second processing path may employ a long short-term memory (LSTM) model configured as described below. In other implementations, the number of hidden units, sequence length, number of layers, or recurrent architecture may vary depending on system constraints or performance objectives. The processor 105 may establish communication pathways between the first and second processing circuits 322, 323 and a feedback and output circuit 324. The communication between the first and second processing circuits 322, 323 and the feedback and output circuit 324 may enable dynamic adjustment of processing parameters of the first and second processing circuits 322, 323. This dual-path loading process may create a complementary processing architecture in which HF signals are analyzed for immediate command generation while LF signals are processed for contextual state information, allowing for comprehensive interpretation of the operator's brainwave patterns.

With combined reference to FIGS. 1 and 3, the pre-processing circuit 321 may include high-throughput analog-to-digital converters (ADCs) 331 and amplifier circuits 332. The ADCs 331, the amplifier circuits 332, or both may condition raw brainwave signals received from the brainwave recorder 102. The ADCs 331, the amplifier circuits 332, or both may filter the brainwave signals, remove artifacts from the brainwave signals, or both to eliminate noise (e.g., due to eye movements, muscle interference, or baseline drifts). The ADCs 331, the amplifier circuits 332, or both may suppress noise and interference, and preserve signal integrity of the brainwave signals across a broad frequency range.

In some examples, the amplifier circuits 332 may include programmable gain stages, filters, and impedance-matching circuitry to accommodate varying signal amplitudes and sensing electrode characteristics. The amplifier circuits 332 may preprocess the brainwave signals to filter out noise components. The ADCs 331 may support high sampling rates and multi-channel conversion to enable simultaneous acquisition of brainwave signals with reduced latency.

In some examples, the pre-processing circuit 321 segments the HF brainwave signals and the LF brainwave signals by applying a FFT to extract the HF brainwave signals from the brainwave signals.

The ADCs 331 may filter the brainwave signals by applying bandpass filtering to prevent brainwave signals outside a band of frequencies from being provided to the first or second processing circuits 322, 323. For example, the ADCs 331 may apply a low pass filter to permit the LF brainwave signals to be provided to only the second processing circuit 323 and may apply a high pass filter to permit the HF brainwave signals to be provided to only the first processing circuit 322. Additionally or alternatively, the ADCs 331 may perform independent component analysis (ICA) to filter out the artifacts.

The first processing circuit 322 (e.g., the local path) may receive the HF brainwave signals from the pre-processing circuit 321. The first processing circuit 322 may process the HF brainwave signals to generate the command data. In particular, the first processing circuit 322 may process the HF brainwave signals to extract HF features (e.g., frequency features).

The FFT circuit 351 may perform FFTs on the HF brainwave signals to extract HF features. The FFT circuit 351 may receive the HF brainwave signals from the pre-processing circuit 321. The FFT circuit 351 may apply FFT algorithms to transform the HF brainwave signals from a time-domain to a frequency-domain. Transforming the HF brainwave signals to the frequency-domain may enable the HF features (e.g., spectral features) that are indicative of immediate control commands or rapid cognitive processes of the operator 101 to be extracted.

The FFT circuit 351 may segment the HF brainwave signals into short time frames. For example, the FFT circuit 351 may segment the HF brainwave signals into thirty two to sixty four millisecond time frames (e.g., windows). These short time frames may be selected to capture transient neural events while maintaining temporal resolution. The FFT circuit 351 may apply windowing functions, such as Hamming or Hanning windows, to each segment to reduce spectral leakage effects. The FFT circuit 351 may perform the FFT operations on each windowed segment to generate the HF features.

The HF features may include power spectral density estimates across the beta frequency band or the gamma frequency band. The HF features may indicate patterns associated with specific motor intentions or cognitive states of the operator 101. For example, increased power in certain gamma frequency bands may correlate with an intention of the operator 101 to command the external device (ED) 108 to ascend, while specific patterns in the beta band may correlate with an intention of the operator 101 to command the external device (ED) 108 to rotate or change direction.

The FFT circuit 351 may also extract phase information from the HF brainwave signals, which may provide additional HF features for command recognition. The phase relationships between HF features or between signals from different EEG channels may contain valuable information about intended commands of the operator 101. The HF features may be organized into feature matrices or tensors.

The first processing circuit 322 may provide the HF features to the CNN model 352. The CNN model 352 may map the HF features to specific commands (e.g., actions) for the external device (ED) 108. The first processing circuit 322 may execute the CNN model 352 to recognize specific patterns in the HF features that correspond to different actions or commands for the external device (ED) 108. The CNN model 352 may generate the command data based on the specific commands for the external device (ED) 108 to which the HF features are mapped. The command data may be representative of the commands to be performed by the external device (ED) 108.

The second processing circuit 323 (e.g., the global path) may receive the LF brainwave signals from the pre-processing circuit 321. The second processing circuit 323 may process the LF brainwave signals to generate the state data.

The second processing circuit 323 may provide the LF brainwave signals to the down sample circuit 361 to isolate LF components (e.g., alpha components or theta components) in the LF brainwave signals. The second processing circuit 323 may provide the LF components to the LSTM model 362. The LSTM model 362 may process the LF components to estimate the state of the operator 101 by analyzing temporal patterns in the LF components. The LSTM model 362 may generate state data related to the state (e.g., cognitive condition) of the operator 101.

The LSTM model 362 may process the LF components through a recurrent neural network architecture specifically designed to capture long-term dependencies in sequential data. The LSTM model 362 may maintain internal memory states to track changes in a cognitive condition of the operator 101 over periods of time. Tracking changes in the cognitive condition of the operator 101 may allow aspects such as attention level, mental workload, fatigue, or emotional state of the operator 101 to be tracked.

The state data may include a state vector that represents various aspects of the cognitive condition of the operator 101. The state data may represent probability estimates for different cognitive states, such as high versus low attention, normal versus elevated stress, or optimal versus suboptimal mental workload. The LSTM model 362 may be trained on datasets containing labeled examples of brainwave patterns associated with different cognitive states, enabling it to generalize to new data from the operator 101.

The state data may serve as a contextual framework for interpreting the command data generated by the first processing circuit 322. For example, if the state data indicates high operator fatigue, the processor 105 may adjust thresholds for command detection or implement additional verification steps before generating the command set including a sequence of potentially risky maneuvers. This integration of immediate command intentions with longer-term cognitive state assessment may enable a more robust and reliable brain-computer interface for external device (ED) control.

The feedback and output circuit 324 may cause processing parameters of the first processing circuit 322, the second processing circuit 323, or both to be adjusted. The feedback and output circuit 324 may receive the command data from the first processing circuit 322 and the state data from the second processing circuit 323. The feedback and output circuit 324 may analyze these inputs to determine how to adjust the processing parameters to improve accuracy, reliability, or any other aspect of the command set.

The feedback and output circuit 324 may temporally align the command data and the state data to ensure proper synchronization of the actions to be performed by the external device (ED) 108 and a longer-term assessment of the state of the operator 101. The temporal alignment may allow the feedback and output circuit 324 to account for the HF brainwave signals being processed by the first processing circuit 322 at different rates than the LF brainwave signals being processed by the second processing circuit 323. The feedback and output circuit 324 may implement buffer mechanisms to hold the command data until corresponding state data becomes available or may employ predictive algorithms to anticipate state changes based on historical patterns.

The feedback and output circuit 324 may dynamically identify various processing parameters to be adjusted based on the comparison between command data and state data. The processing parameters that may be adjusted may include filter coefficients in the pre-processing circuit 321, threshold values for spike detection in the FFT circuit 351, learning rates or activation thresholds in the CNN model 352, temporal window sizes for the down sample circuit 361, or gating parameters in the LSTM model 362. For example, if the state data indicates high operator fatigue, the feedback and output circuit 324 may cause detection thresholds in the first processing circuit 322 to be increased to reduce the likelihood of false command detection.

The feedback and output circuit 324 may implement a weighted fusion algorithm to combine the command data and the state data with appropriate weighting factors. The weighting factors may be dynamically adjusted based on the confidence levels associated with each processing path. For instance, if the first processing circuit 322 produces command data with high confidence scores while the second processing circuit 323 indicates uncertainty in the state of the operator 101, the feedback and output circuit 324 may assign higher weights to the command data.

The feedback and output circuit 324 may adapt to changing environmental conditions or operational contexts. For example, in high-noise environments, the feedback and output circuit 324 may increase the reliance on the second processing circuit 323 to reduce susceptibility of the processor 105 to environmental interference. Conversely, in scenarios requiring rapid response, the feedback and output circuit 324 may prioritize the first processing circuit 322 to generate the command set more quickly.

Additionally, the feedback and output circuit 324 may maintain historical performance metrics for the first and second processing circuits 322, 323 and use this information to adjust the processing parameters over time. The feedback and output circuit 324 may track success rates of execution of command sets, operator satisfaction indicators, or system response times to continuously track and adjust the processing parameters.

The feedback and output circuit 324 may implement cross-validation between the first and second processing circuits 322, 323 to enhance reliability. If the command data from suggests an action that contradicts the cognitive state indicated by the second processing circuit 323, the feedback and output circuit 324 may flag this discrepancy and either request additional processing cycles or implement a predefined conflict resolution strategy before generating the command set.

The feedback and output circuit 324 may dynamically adjust the CNN thresholds or the LSTM hyperparameters based on the feedback received from both processing paths. For example, if the state data from the second processing circuit 323 indicates high operator fatigue, the feedback and output circuit 324 may increase detection thresholds in the CNN model 352 to reduce the likelihood of false command detection during periods of operator fatigue. Similarly, if the feedback indicates consistent discrepancies between the command data and the state data, the feedback and output circuit 324 may modify gating parameters in the LSTM model 362 to better track changes in the cognitive state of the operator 101. These adjustments may be implemented through parameter update packets transmitted via an internal bus, allowing the system to continuously optimize its performance without interrupting the ongoing neural signal processing, thereby maintaining reliable external device (ED) control even as the operator's cognitive state or environmental conditions change.

The processor 105 may receive data from the external device (ED) 108 to monitor execution of the command set and operational parameters. The data may be received via the antenna 106. The processor 105 may receive various types of operational parameters from the external device (ED) 108, including global positioning system information, internal measurement unit information, obstacle detection information, wind speed information, battery status, altitude, heading, speed, or any other appropriate operational parameter. The processor 105 may analyze this feedback data to determine the current state and performance of the external device (ED) 108.

The processor 105 may continuously monitor the execution of the command set by the external device (ED) 108 through the received data. For example, the processor 105 may track whether the external device (ED) 108 is properly executing the sequence of actions specified in the command set. The processor 105 may compare the actual trajectory or behavior of the external device (ED) 108 with the expected trajectory or behavior based on the command set. The data received from the external device (ED) 108 may indicate operations (e.g., environmental data) obtained by sensors of the external device (ED) 108.

Based on the data received from the external device (ED) 108, the processor 105 may adjust various processing parameters. For example, if the processor 105 determines that the external device (ED) 108 is operating in high wind conditions based on the received wind speed data, the processor 105 may modify the thresholds used in the first processing circuit 322 to require stronger or more consistent brainwave signals before generating certain movement commands.

The processor 105 may also adjust the weighting factors used in the feedback and output circuit 324 based on the operational parameters. For instance, if the data indicates that the external device (ED) 108 is experiencing difficulty maintaining stability due to environmental factors such as high wind speed, the processor 105 may increase the weight assigned to the state data from the second processing circuit 323 relative to the command data from the first processing circuit 322.

The processor 105 may maintain historical records of how different operational parameters affect execution success rates of command sets. The processor 105 may develop optimized parameter sets for various operating conditions, which may be automatically applied when similar conditions are detected in future operations.

The processor 105 may generate operation status reports that include information about operation of the external device (ED) 108, brainwave signal processing, the state of the operator 101, or some combination thereof. The mission status report may indicate command execution success rates, operator cognitive conditions, environmental factors affecting performance of the external device (ED) 108, or system adaptation parameters. The processor 105 may analyze the data received from the external device (ED) 108, outputs from the first or second processing circuits 322, 323, or historical performance metrics. The mission status report may be used for post-mission analysis.

A display (not shown) may display various types of data related to the BCI system 107, the operator 101, the external device (ED) 108, or some combination thereof. The display may show real-time visualizations of the brainwave signals captured by the brainwave recorder 102, including waveform representations of different frequency bands such as delta, theta, alpha, beta, and gamma waves. The display may display graphical representations of the command data, the state data, or data related to the external device (ED) 108 such as altitude, heading, speed, and battery status.

Prior to controlling the external device (ED) 108 or as part of a power-up sequence, the BCI system 107 may perform a calibration session to establish baseline brainwave patterns for the operator 101. During this calibration session, the operator 101 may be instructed to perform specific mental tasks, such as imagining different external device (ED) actions or maintaining various cognitive states like focused attention or relaxation. The brainwave recorder 102 may capture these baseline signals while the processor 105 may analyze the patterns to establish personalized thresholds and parameters for both the first processing circuit 322 and the second processing circuit 323.

The calibration session may also include environmental adaptation procedures to account for potential electromagnetic interference or other external factors that could affect signal quality during the mission. The processor 105 may store these calibration parameters and may use them as reference points during actual operation. Additionally, the calibration session may include a series of test commands to verify system functionality, allowing the operator 101 to confirm that the BCI system 107 correctly interprets their mental commands before sending the command set to the external device (ED) 108.

The processor 105 may periodically update the CNN model 352 or the LSTM model 362 based on updated training data. At predetermined intervals, such as daily or weekly, or when performance metrics indicate a decline in accuracy, the processor 105 may initiate a background training process to refine the model parameters. This update process may be performed during periods of low system activity to minimize interference with real-time operations. The updated models may incorporate new neural patterns that emerge due to operator learning, environmental changes, or variations in mission parameters, thereby ensuring that the BCI system 107 maintains high decoding accuracy and adapts to evolving operational conditions over time.

The BCI system 107 may include fail-safe mechanisms that cause the external device (ED) 108 to revert to known or stable autopilot modes if operation of the BCI system 107 becomes unreliable. For example, if the brainwave recorder 102 detects signal degradation below predetermined quality thresholds, if the processor 105 identifies inconsistencies between the command data and state data exceeding acceptable parameters, or if communication between the antenna 106 and the external device (ED) 108 experiences interference or packet loss above critical levels, the BCI system 107 or the external device (ED) 108 may trigger a safety protocol that transitions control to a pre-programmed autopilot mode such as hover-in-place, return-to-home, or controlled descent.

FIG. 2 illustrates a block diagram of an example operational environment 200 for using a BCI system 207, in accordance with at least one embodiment described in the present disclosure. The environment 200 includes multiple users 201a-b (e.g., users), the BCI system 207, and a network 210. The BCI system 207 may include multiple brainwave recorders 202a-b, the computing device 104 of FIGS. 1 and 3, or user devices 203a-b.

The operators 201a-b may wear or otherwise be connected to a corresponding instance of the brainwave recorders 202a-b. The brainwave recorders 202a-b may be communicatively coupled to the computing device 104 including the processor 105 via the network 210. The brainwave recorders 202a-b may correspond to the brainwave recorder 102 described above in relation to FIG. 1.

The environment 200 may include any appropriate environment and the BCI system 207 may be implemented to facilitate interactions between the operators 201a-b. For example, the environment 200 may include a healthcare facility and the BCI system 207 may facilitate interactions between the operators 201a-b when performing a remote operation. As another example, the environment 200 may include a school and the BCI system 207 may facilitate interactions between a teacher (e.g., the operator 201a) and a student (e.g., the operator 201b) to track comprehension levels. As yet another example, the environment 200 may include a gaming system to facilitate interactions between the operators 201a-b playing a game together.

The first brainwave recorder 202a may capture the brainwave signals of the first operator 201a. The second brainwave recorder 202b may capture the brainwave signals of the second operator 201b. The brainwave recorders 202a-b may be communicatively coupled to the network 210 via a wired connection (e.g., a universal serial bus), a wireless connection (e.g., WiFi, near field communication, or Bluetooth), or both.

The network 210 may include any communication network configured for communication of signals between any of the components (e.g., 203a-b, 202a-b, or 104) of the environment 200. The network 210 may be wired or wireless. The network 210 may have numerous configurations including a star configuration, a token ring configuration, or another suitable configuration. Furthermore, the network 210 may include a local area network (LAN), a wide area network (WAN) (e.g., the Internet), and/or other interconnected data paths across which multiple devices may communicate. In some embodiments, the network 210 may include a peer-to-peer network. The network 210 may also be coupled to or include portions of a telecommunications network that may enable communication of data in a variety of different communication protocols.

In some embodiments, the network 210 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 210 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the user devices 203a-b, the brainwave recorders 202a-b, or the computing device 104.

The user devices 203a-b may include general-purpose computers, specialized computers, mobile devices, personal digital assistants (PDAs), cell phones, tablets, laptops, set-top boxes, wearable devices, or any other processor-enabled devices that may store, retrieve, and process data.

The processor 105 may receive the brainwave signals of the operators 201a-b via the network 210. As described in more detail below, the processor 105 may segment the brainwave signals of the operators 201a-b into HF brainwave signals and LF brainwave signals. The first processing circuit (e.g., first processing circuit 322 of FIG. 3) of the processor 105 may generate decision data related to the operators 201a-b based on the HF brainwave signals. The second processing circuit (e.g., the second processing circuit 323 of FIG. 3) may generate state data related to states of the operators 201a-b based on the LF brainwave signals. The processor 105 may determine a synchronization state of the operators 201a-b on the decision data and the state data. The synchronization state may indicate an amount of synchronization between the brainwave signals of the operators 201a-b. The synchronization state may indicate commands or decisions made by the first operator 201a, the second operator 201b, or both.

The processor 105 may generate synchronization data representative of the synchronization state of the operators 201a-b. The processor 105 may encode the synchronization data into packets that comprise a local component associated with the decision data and a global component associated with the state data. In some embodiments, the processor 105 may cause the synchronization data to be transmitted to one or more of the user devices 203a-b. For example, the processor 105 may cause the synchronization data to be transmitted to one or more of the user devices 203a-b via the network 210. The one or more user devices 203a-b may display the synchronization state of the operators 201a-b via user interfaces (not shown) or displays (not shown) of the user devices 203a-b.

In some embodiments, the operators 201a-b may be co-located in the same physical location (e.g., a single room, building, or location). In these and other embodiments, the computing device 104 may include a local computing device or local server configured to perform operations described in the present disclosure as part of a LAN. In other embodiments, the operators 201a-b may be located remotely to each other (e.g., different physical locations). In these and other embodiments, the computing device 104 may include a cloud-based computing device or cloud-based server (e.g., the processor 105 is a cloud-based processor) configured as a distributed computing device.

With combined reference to FIGS. 2 and 3, the ADCs 331, the amplifier circuits 332, or both may condition brainwave signals received from the brainwave recorders 202a-b. The ADCs 331, the amplifier circuits 332, or both may filter the brainwave signals, remove artifacts from the brainwave signals, or both to eliminate noise (e.g., due to eye movements, muscle interference, or baseline drifts). The ADCs 331, the amplifier circuits 332, or both may suppress noise and interference, and preserve signal integrity of the brainwave signals across a broad frequency range. The amplifier circuits 332 may preprocess the brainwave signals to filter out noise components.

In some examples, the pre-processing circuit 321 segments the HF brainwave signals and the LF brainwave signals by applying a FFT to extract the HF brainwave signals from the brainwave signals. The ADCs 331 may filter the brainwave signals by applying bandpass filtering to prevent brainwave signals outside a band of frequencies from being provided to the first or second processing circuits 322, 323. Additionally or alternatively, the ADCs 331 may perform ICA to filter out the artifacts.

The pre-processing circuit 321 may synchronize timestamps of the brainwave signals before distribution to the first processing circuit 322 and the second processing circuit 323. In some embodiments, the pre-processing circuit 321 may receive channel-specific sampling clocks from the ADCs 331 and may align these sampling clocks to a common reference time base. The pre-processing circuit 321 may maintain a timing register for each brainwave recorder 202a-b. The pre-processing circuit 321 may append a synchronized timestamp tag to each brainwave signal or to each frame of the brainwave signals.

The pre-processing circuit 321 may compensate for latency differences between the brainwave recorders 202a-b or the network 210 by applying per-source delay offsets. The pre-processing circuit 321 may estimate these delay offsets based on periodic calibration pulses, round-trip time measurements, or cross-correlation between redundant synchronization markers embedded in the brainwave signals. The pre-processing circuit 321 may employ interpolation or resampling logic to adjust sample positions in time so that brainwave signals of the operators 201a-b reach the first processing circuit 322 and the second processing circuit 323 with aligned timestamps.

The pre-processing circuit 321 may encode the HF brainwave signals into discrete analysis frames that may be formatted for processing by the first processing circuit 322. The pre-processing circuit 321 may route digitized samples from the ADCs 331 through a HF bandpass stage that may apply programmable high-pass and low-pass cutoff frequencies selected to isolate beta and gamma components. The pre-processing circuit 321 may segment the HF brainwave signals into contiguous or overlapping time windows and may normalize amplitudes within each window to a reference level derived from calibration baselines. The pre-processing circuit 321 may compute preliminary spectral descriptors for various periods of time corresponding to the HF brainwave signals.

The first processing circuit 322 (e.g., the local path) may receive the HF brainwave signals from the pre-processing circuit 321. The first processing circuit 322 may process the HF brainwave signals to generate the decision data. In particular, the first processing circuit 322 may process the HF brainwave signals to extract HF features (e.g., frequency features).

The FFT circuit 351 may perform FFTs on the HF brainwave signals of the operators 201a-b to extract HF features. The FFT circuit 351 may receive the HF brainwave signals of the operators 201a-b from the pre-processing circuit 321. The FFT circuit 351 may apply FFT algorithms to transform the HF brainwave signals from the time-domain to the frequency-domain. Transforming the HF brainwave signals to the frequency-domain may enable the HF features (e.g., spectral features) that are indicative of immediate events of the operators 201a-b such as attention bursts, short-term decisions to be extracted.

The FFT circuit 351 may segment the HF brainwave signals of the operators 201a-b into short time frames. For example, the FFT circuit 351 may segment the HF brainwave signals into thirty two to one hundred millisecond time frames (e.g., windows). These short time frames may be selected to capture transient neural events while maintaining temporal resolution. The FFT circuit 351 may apply windowing functions, such as Hamming or Hanning windows, to each segment to reduce spectral leakage effects. The FFT circuit 351 may perform the FFT operations on each windowed segment to generate the HF features.

The HF features may include power spectral density estimates across the beta frequency band or the gamma frequency band. The HF features may indicate patterns associated with specific attention bursts, short-term decisions, or focus of the operators 201a-b. For example, increased power in certain gamma frequency bands may correlate with an increased attention of the operator 201b and increased power in another gamma frequency band may correlate with a specific decision of the operator 201b.

The FFT circuit 351 may also extract phase information from the HF brainwave signals, which may provide additional HF features for decision recognition. The phase relationships between HF features or between signals from different EEG channels may contain valuable information about intended decisions of the operators 201a-b. The HF features may be organized into feature matrices or tensors.

The first processing circuit 322 may provide the HF features to the CNN model 352. The CNN model 352 may map the HF features to specific commands or decisions of the operators 201a-b. The first processing circuit 322 may execute the CNN model 352 to recognize specific patterns in the HF features that correspond to different commands or decisions of the operators 201a-b. The CNN model 352 may generate the decision data based on the specific commands or decisions to which the HF features are mapped. The decision data may be representative of the commands or the decisions of the operators 201a-b.

The second processing circuit 323 (e.g., the global path) may receive the LF brainwave signals of the operators 201a-b from the pre-processing circuit 321. The second processing circuit 323 may process the LF brainwave signals to generate the state data.

The second processing circuit 323 may provide the LF brainwave signals of the operators 201a-b to the down sample circuit 361 to isolate LF components (e.g., alpha components or theta components) in the LF brainwave signals. The second processing circuit 323 may provide the LF components to the LSTM model 362. The LSTM model 362 may process the LF components of the operators 201a-b to estimate the states of the operators 201a-b by analyzing temporal patterns in the LF components. The LSTM model 362 may generate the state data related to the state (e.g., cognitive condition) of the operators 201a-b.

The LSTM model 362 may process the LF components through a recurrent neural network architecture specifically designed to capture long-term dependencies in sequential data. The LSTM model 362 may maintain internal memory states to track changes in a cognitive conditions of the operators 201a-b over periods of time. Tracking changes in the cognitive conditions of the operators 201a-b may allow aspects such as attention level, mental workload, fatigue, or emotional states of the operators 201a-b to be tracked.

The state data may include a state vector that represents various aspects of the cognitive conditions of the operators 201a-b. The state data may represent probability estimates for different cognitive states, such as high versus low attention, normal versus elevated stress, or optimal versus suboptimal mental workload. The LSTM model 362 may be trained on datasets containing labeled examples of brainwave patterns associated with different cognitive states, enabling it to generalize to new data from the operators 201a-b.

The state data may serve as a contextual framework for interpreting the decisions data generated by the first processing circuit 322. For example, if the state data indicates high operator fatigue, the processor 105 may adjust thresholds for command or decisions detection or implement additional verification steps before generating the decision data. This integration of immediate decision or command intentions with longer-term cognitive state assessment may enable a more robust and reliable brain-computer interface for multiple operators 201a-b.

The feedback and output circuit 324 may cause processing parameters of the first processing circuit 322, the second processing circuit 323, or both to be adjusted. The feedback and output circuit 324 may receive the decision data from the first processing circuit 322 and the state data from the second processing circuit 323. The feedback and output circuit 324 may analyze these inputs to determine how to adjust the processing parameters to improve accuracy, reliability, or any other aspect of the decision data or the state data.

The feedback and output circuit 324 may monitor the state data associated with the operators 201a-b over successive periods of time. The feedback and output circuit 324 may receive, from the second processing circuit 323, a time series of state vectors that may correspond to consecutive LF component segments for each of the operators 201a-b. The feedback and output circuit 324 may compute temporal statistics from the state vectors, such as moving averages, variances, or cross-correlations that may characterize how the cognitive conditions of the operators 201a-b evolve over the periods of time. The feedback and output circuit 324 may maintain a sliding history buffer for the state data of each operator 201a-b so that gradual drifts, abrupt transitions, or recurring patterns in the cognitive conditions may be tracked and compared across the operators 201a-b.

The feedback and output circuit 324 may adjust one or more signal processing parameters of at least one of the first processing circuit 322 or the second processing circuit 323 based on the monitored states of the operators 201a-b. The feedback and output circuit 324 may adjust the signal processing parameters to align at least one of a phase, a frequency, or an amplitude of the brainwave signals of the operators 201a-b. In some embodiments, the feedback and output circuit 324 may determine differences or discrepancies between the amplitude, phase, or frequency of the brainwave signals of the different operators 201a-b to determine the adjustments to be made to the signal processing parameters to be made.

The feedback and output circuit 324 may update path weights of the dual-path processing arrangement to align the brainwave signals of the operators 201a-b. The feedback and output circuit 324 may adjust, for example, adaptive gain coefficients for amplitude normalization, dynamic phase-alignment offsets, or center frequencies for narrowband filters.

The feedback and output circuit 324 may shift analysis windows of the HF brainwave signals in the first processing circuit 322 so that the brainwave signals of the operators 201a-b are phase-locked. Alternatively or additionally, the processor 105 may tune LF bandpass filters or resampling ratios in the second processing circuit 323 based on frequency-alignment instructions so that peaks of the brainwave signals of the operators 201a-b are brought into closer spectral proximity. The feedback and output circuit 324 may update amplitude scaling factors for channel-wise normalization so that relative power distributions across corresponding frequency bands of the brainwave signals of the operators 201a-b converge.

The feedback and output circuit 324 may monitor a synchronization metric that represents synchronization between the brainwave signals of the operators 201a-b. The feedback and output circuit 324 may derive the synchronization metric from combined analysis of the decision data and the state data associated with the operators 201a-b. The feedback and output circuit 324 may compute the synchronization metric using phase-locking values, cross-correlation coefficients, or other similarity measures applied to phase, frequency, or amplitude components extracted from the first processing circuit 322, the second processing circuit 323, or both. The feedback and output circuit 324 may compare the synchronization metric to one or more threshold values. The feedback and output circuit 324 may detect when the operators 201a-b are not synchronized based on a phase mismatch or mismatch of any other signal feature.

In response to determine the operators 201 are not synchronized, the feedback and output circuit 324 may update or adjust the dual-path processing arrangement to recalibrate synchronization between the operators 201a-b. For example, the feedback and output circuit 324 may boost an update rate or gain factor associated with at least one of the first processing circuit 322 or the second processing circuit 323. As another example, the feedback and output circuit 324 may reduce processing fidelity of the dual-path processing arrangement if bandwidth is limited or otherwise constrained.

The processor 105 may encrypt at least a portion of the decision data for transmission to the user devices 203a-b. The processor 105 may select an encryption mode for the decision data that reduces processing cycles so that temporal characteristics of the HF brainwave signals may be preserved. In some embodiments, the processor 105 may classify the decision data as fast data and may assign a lower cryptographic complexity profile to the decision so that latency introduced by security processing of the decision data is reduced.

The processor 105 may encrypt the decision data using symmetric ciphers to protect the decision data with minimal latency. For example, the processor 105 may implement advanced encryption standard (AES) with simplified keys. The processor 105 may employ, for example, a block cipher or a stream cipher configured in a symmetric mode so that the same cryptographic key may be used for both encryption and decryption of the decision data. The processor 105 may integrate a lightweight hardware or software encryption engine into the first processing circuit 322 or into a dedicated submodule of the feedback and output circuit 324 so that encryption of the decision data may be performed in parallel with feature extraction and classification operations without requiring additional data transfers.

The processor 105 may encrypt at least a portion of the state data for transmission to the user devices 203a-b. The processor 105 may select an encryption mode for the state data that is more secure compared to the encryption used for the decision data. The processor 105 may encrypt the state data using symmetric encryption techniques with increased cryptographic strength, such as Advanced Encryption Standard (AES) with longer key lengths. In some embodiments, asymmetric cryptographic techniques, such as Rivest-Shamir-Adleman (RSA), may be used for key exchange or session establishment rather than for bulk data encryption. The processor 105 may integrate a hardware or software encryption engine into the second processing circuit 323 or into a dedicated submodule of the feedback and output circuit 324 so that encryption of the state data may be performed in parallel with feature extraction and classification operations without requiring additional data transfers.

The processor 105 may dynamically rotate the encryption keys to maintain security integrity over extended periods of time. In some embodiments, encryption keys may be rotated based on session context, temporal intervals, operator identity, or system state transitions. In other embodiments, system-derived indicators, including changes in neural signal characteristics, may be used as auxiliary inputs to trigger key rotation events, without relying on neural signals as a direct source of cryptographic entropy.

The processor 105 may set or dynamically rotate the encryption keys based on a session so as to respond to real-time changes in the environment 200. For example, the processor 105 may set or update the encryption keys when a new operator joins a session or an operator leaves a session. As another example, the processor 105 may set or update the encryption keys when an emotional state of one or more of the operators 201a-b changes.

The processor 105 may determine the synchronization state of the operators 201a-b based on the decision data and the state data. The processor 105 may compute, for a period of time, similarity measures between the decision data, the state data, or both of the operators 201a-b. For example, the processor 105 may determine a cross-correlation, a cosine similarity, or a mutual information of the decision data, the state data, or both of the operators 201a-b. The processor 105 may classify the synchronization state into one of several synchronization levels, such as low, medium, or high synchronization. The processor 105 may associate each synchronization level with metadata that may include which operator 201a-b initiated decisions and how consistently those decisions align with the other operator 201a-b

The processor 105 may encode the synchronization data, the decision data, the state data, or some combination thereof according to a layered priority scheme. The processor 105 may assign a first priority layer to the decision data and a second priority layer the state data. The processor 105 may encode the decision data or the synchronization data into local components (e.g., short term packets) of packet headers or payload regions that may occupy a fixed-length. The processor 105 may place the state data into global components (e.g., long term packets) of packet headers that may occupy an extended field. The processor 105 may encode the decision data or the synchronization data before the state data. The processor 105 may apply a compact encoding format to the decision data or the synchronization data to minimize bit-length, such as differential coding or reduced-precision quantization. The processor 105 may apply a less compact encoding format to the state data.

The processor 105 may interact with the feedback and output circuit 324 to implement the layered priority transmission over the network 210. The processor 105 may tag each packet containing the decision data with a higher-priority identifier and may tag each packet containing only the state data with a lower-priority identifier. The processor 105 may configure a transmission queue in which packets carrying decision data are provided before packets that contain state data.

The processor 105 may cause a communication interface of the computing device 104 to encapsulate the encoded data into frames suitable for transmission over the network 210. The communication interface may include a network interface controller that may format the encoded data into Ethernet frames, wireless frames, or other link-layer units depending on a configuration of the network 210. The processor 105 may instruct the communication interface to transmit the encoded data to the user devices 203a-b via the network 210.

The user devices 203a-b may decode the packets received from the computing device 104 and may display information based on the decision data, the state data, or the synchronization data encoded therein. Each user device 203a-b may include a display (not shown) configured to render the synchronization data, the decision data, or the state data as visual indicators. In some embodiments, the user devices 203a-b may display the synchronization state as a time-varying gauge, bar, or heat map whose level or color may correspond to a current synchronization level derived from the synchronization data. Alternatively or additionally, the user devices 203a-b may display decision indicators that may identify which operator 201a-b contributed a particular decision, a confidence level associated with the decision data, or a recent history of such decisions.

The user devices 203a-b may display information that represents attention, workload, fatigue, or other cognitive aspects of the operators 201a-b. In some embodiments, the display of each user device 203a-b may include a timeline region that may show how the state data of the corresponding operator 201a-b and the other operator 201a-b may evolve over time. The user devices 203a-b may annotate the displayed state data with markers that may indicate transitions between different synchronization levels, events where the feedback and output circuit 324 updated processing parameters, or moments where discrepancies between the decision data and the state data exceeded a threshold.

The BCI system 207 may periodically calibrate the brainwave recorders 202a-b in the same or similar manner as described above in relation to the brainwave recorder 102 of FIG. 1. In addition, the processor may periodically update the CNN model 352 or the LSTM model 362 based on updated training data as described above in relation to FIG. 1. The processor 105 may perform hardware checks on elements of BCI system 207 to confirm expected operator of the elements.

FIG. 4 illustrates a flowchart showing a method 400 for processing brainwave signals associated with brain activities of an operator in accordance with examples as disclosed herein. The method 400 implements a dual-path processing arrangement that separates the brainwave signals into HF brainwave signals and LF brainwave signals, processes them independently, and integrates their outputs to generate command sets for controlling an external device. The method 400 can be performed by a computing device (e.g., computing device 104 described and shown in relation to FIGS. 1 and 3).

At block 402 in FIG. 4, the computing device obtains a plurality of brainwave signals. The computing device receives raw brainwave signals from one or more brainwave recorders. These brainwave signals may originate from EEG, ECoG, local field potentials (LFPs), or intracortical microelectrode arrays. The one or more brainwave decoders may include, for example, 128-channel dry electrodes array. These dry electrodes may be deposed at different locations in human's (or an animal's) brain area to obtain the brainwave signals. In non-invasive embodiments, the electrodes may capture oscillatory brainwave activity observable at the scalp. In other embodiments employing invasive or semi-invasive neural interfaces, such as intracortical microelectrodes or electrocorticography (ECOG) arrays, the electrodes may additionally capture spike-related activity or local field potentials associated with neuronal firing. Each dry electrode (e.g., channel) captures voltage or current fluctuations caused by neuronal firing activities. The sampling rate of the dry electrodes array may be from 0.5 Hz to 5 kHz (e.g., for scalp EEG) or even up to thirty kHz (e.g., for intracortical recordings).

For example, the brainwave decoders may include an EEG cap with 128-channel dry electrodes array. The EEG cap records brain activity during a motor imagery task (where a person mentally rehearses a movement without any actual muscle movement), generating digital signals represented as xᵢ(t), where i denotes channel index and t denotes time. For 128-channel dry electrodes array with 100 ms test, the computing device may obtain digital signals represented as ×128(100).

At block 404, the computing device separates HF brainwave signals from LF brainwave signals. The obtained brainwave signals contain both HF brainwave signals and LF brainwave signals. In non-invasive embodiments, HF brainwave signals may include frequencies above approximately 30 Hz. In invasive or semi-invasive embodiments, HF brainwave signals may additionally include higher-frequency components, such as spike-related activity extending into the kilohertz range. The HF brainwave signals may be from 30 Hz to 5 kilohertz (kHz), and the LF brainwave signals may be from 0.5 Hz to 30 Hz. HF brainwave signals generally correspond to short-term neural activity, such as transient gamma-band oscillations or other rapid cortical dynamics. In embodiments utilizing invasive or semi-invasive recording techniques, the HF brainwave signals may additionally include spike-related activity or local field potentials. The LF brainwave signals generally correspond to long-term neural activity, such as slow cortical potentials, delta (0.5-4 Hz), theta (4-8 Hz), or alpha (8-12 Hz) bands, which reflect global brain states such as attention, fatigue, or intention buildup.

The separation of the HF brainwave signals and the LF brainwave signals may be achieved by digital filtering, such as a high-pass filter (e.g., cutoff ~30 Hz) for extracting the HF brainwave signals and a low-pass filter (e.g., cutoff ~0.5 Hz) for the LF brainwave signals. Alternatively, wavelet decomposition or short-time Fourier transform (STFT) may be employed to achieve multi-frequency separation.

At block 406, the computing device processes the HF brainwave signals in a first processing path (also referred to as local path) to generate the command data. The first processing path is dedicated to analyzing the HF brainwave signals to extract features indicative of short-term neural activity of the operator. The short-term neural activity refers to rapid, localized events such as neuronal spikes indicating action potentials; HF bursts associated with sensory processing or motor initiation; or transient gamma oscillations reflecting active cognitive computation.

In the first processing path (also referred to as local path), the HF brainwave signals may be input into a CNN model or an equivalent feature extractor. The CNN model may detect temporal and spatial patterns across channels that represent spike occurrences or fast modulations, and generates features depending on the detected patterns. For example, a 2-layer CNN model may compute convolutional kernels over both time and channel dimensions to detect micro-patterns of the HF brainwave signals such as HF bursts or synchronized gamma oscillations. The output of CNN model is may be the command data.

At block 408, the computing device processes the LF brainwave signals in a second processing path (also referred to as global path) to generate state data. The second processing path deals with the LF brainwave signals to derive features representing long-term neural activity or global state of a brain. The long-term neural activity corresponds to gradual changes over seconds, such as fatigue accumulation indicated by rising theta power; sustained attention represented by alpha suppression; and motor intention buildup reflected in mu-rhythm desynchronization.

The second processing path (also referred to as global path) may use a LSTM model or any equivalent models. An LSTM is a type of RNN (Recurrent Neural network) capable of capturing temporal dependencies over extended durations. It maintains cell states and gates (e.g., input gate, forget gate, and output gate) to model sequential patterns in time-series data. The LSTM model receives the LF brainwave signals during input windows (e.g., 2-5 seconds of downsampled signals) and outputs the state data the represents the state of the operator (e.g., focused, fatigued, or intending movement).

It should be noted that although, in the illustrated example, the processing of the HF brainwave signals (e.g., block 406) is shown as occurring prior to the processing of the LF brainwave signals (e.g., block 408), no limitation is intended regarding the order of these operations. The LF brainwave signals may be processed before the HF brainwave signals, or the two processing paths may be executed concurrently or in parallel, depending on system design or implementation preferences.

After the command data and the state data are generated, a command set may be generated based on the command data and the state data.

FIG. 5 illustrates a flowchart showing another method 500 to process brainwave signals in accordance with examples as disclosed herein. The method 500 implements a dual-path processing arrangement that separates the brainwave signals into HF brainwave signals and LF brainwave signals, processes them independently, and integrates their outputs to generate command sets for controlling an external device. The method 500 can be performed by a computing device (e.g., computing device 104 described and shown in relation to FIGS. 1 and 3). As shown in FIG. 5, block 502 corresponds to a similar step as shown at block 402 in FIG. 4; therefore, a detailed description is omitted here.

In some examples, as shown at block 504 in FIG. 5, the computing device may preprocess the plurality of brainwave signals to filter out noise components. For instance, the computing device may apply one or more digital filters, such as a band-pass filter to retain signal components within a target frequency range, a notch filter to suppress power-line interference (e.g., 50/60 Hz noise), or a low-pass filter to reduce HF artifacts. In other examples, the preprocessing may include adaptive filtering techniques that dynamically adjust filter parameters based on detected noise characteristics, or spatial filtering methods (e.g., common average referencing) to reduce common-mode noise across multiple channels.

In some examples, referring to block 506 in FIG. 5, a FFT may be applied to extract HF components from the HF brainwave signals. For example, a 64-point radix-2 FFT may be applied to convert the HF brainwave signals from a time domain to a frequency domain representation. The FFT may convert the incoming time-domain HF brainwave signals into their corresponding frequency spectrum.

The computing device may apply a frequency-selective operation, such as a thresholding or band-pass filtering process, to isolate HF components associated with rapid neuronal events (e.g., action potentials or spike-related activity). For example, the computing device may retain frequency bins above a predetermined cutoff frequency while discarding lower-frequency bins representing slower neuronal events. The resulting signals (e.g., HF components) may then be input into the first processing path to generate at least one first feature (e.g., at least one first vector).

In some embodiments, as described above, the first processing path, also referred to as the local path, is implemented using a CNN model that deals with HF components of the HF brainwave signals. At block 508, the computing device inputs the HF components into the CNN model. At block 510, the CNN may generates the command data. The input to the CNN model may be derived from segmented windows of the input HF components signal, each window having a duration of approximately 32 to 64 milliseconds. In one example, each input window may have a data shape of approximately [128×64] and may include frequency components filtered above about thirty Hz.

The CNN model may include a two-layer model implemented in integer quantization format (e.g., INT8 precision). The CNN model may include a first convolutional layer and a second convolutional layer arranged sequentially. In one example, the first convolutional layer may include a plurality of filter kernels defining eight output channels. Each filter kernel may perform a convolution operation over the input feature map to extract local spatial and temporal features from the input signals. The first convolutional layer may be followed by a nonlinear activation stage employing a rectified linear unit (ReLU) activation function. As used herein, a ReLU activation function is defined in accordance with Equation 1:

$$ReLU ( x ) = max ( 0 , x ) \qquad Equation 1$$

In Equation 1, x represents an input value to the activation function. In operation, the ReLU function outputs the input value x when x is greater than zero and outputs zero when x is less than or equal to zero. This nonlinearity suppresses negative activations and introduces sparsity into the output feature maps, which may provide improved learning capacity and reduced computational load. The numerical values and model configurations described herein are provided by way of example only, and other architectures or parameter values may be used without departing from the scope of the present disclosure.

The output of the first convolutional layer (e.g., after application of the ReLU activation) may be supplied to the second convolutional layer. The second convolutional layer may include filter kernels defining four 4 output channels and may be configured to further extract higher-level or abstracted features from the intermediate feature maps. Similar to the first convolutional layer, the second convolutional layer may also employ a ReLU activation function of the form ReLU(x)=max(0, x) to introduce nonlinearities into the model and allow the CNN to model complex relationships within the transformed signals.

In some examples, the convolutional operations of both the first and second convolutional layers may be executed using a systolic array hardware structure. The systolic array may include a plurality of interconnected processing elements arranged in a regular grid, where data flows rhythmically between processing elements. This enables highly parallelized multiply-accumulate (MAC) operations characteristic of convolutional layers. Utilization of the systolic array structure may improve processing efficiency, reduce latency, and increase throughput when executing the CNN model, particularly for quantized INT8 convolution operations.

The resulting output feature maps from the second convolutional layer may then be aggregated, flattened, or otherwise transformed to generate the command data. The CNN model may be trained on publicly available datasets, such as those from the BCI Competition IV, using a deep learning framework such as PyTorch. During training, the model parameters may be updated using the Adam optimization algorithm with a learning rate of approximately 0.001.

In some embodiments, the CNN model may also output a confidence score, denoted as CCNN, which may be determined based on one minus the entropy of a softmax output.

As mentioned above, the second processing path, also referred to as the global path, may be implemented using LSTM model that deals with LF brainwave signals. Still referring to FIG. 5, at block 514 the computing device down samples the LF brainwave signals to extract LF components. The LF components may be derived from longer windows of the LF brainwave signals, such as two to five second segments. The LF components may be generated by down-sampling the LF brainwave signals to a sampling rate of approximately 200 Hz. Each resulting window may have a data shape of approximately [A×B−C], in which A represents the number of recording channels and B−C corresponds to a number of time samples in the down-sampled segment. These windows may primarily contain signal components in the LF range of approximately 0.1 Hz to approximately eight Hz.

At block 514, the computing device inputs the multiple LF components into a LSTM model. The LSTM model may be implemented as a single-layer recurrent neural network with sixty four hidden units. The LSTM model may include a complete recurrent structure that processes the LF components over multiple time steps. The LSTM model may be formed by repeatedly applying an LSTM cell across the sequence length. As used herein, an LSTM cell represents the fundamental computational unit of the LSTM model responsible for performing the gating operations, updating the internal cell state, and generating the hidden state for a single time step. Thus, the LSTM model may include multiple instances of the same LSTM cell logic, executed sequentially for each time step in the input sequence.

Each LSTM cell may include dual-gate or peephole structures configured to manage long-term dependencies and temporal information. For example, each LSTM cell may include an input gate configured to determine the degree to which new information is incorporated into a cell state; a forget gate configured to determine the degree to which previous cell state information is retained or discarded; and an output gate configured to determine the degree to which the current cell state contributes to the hidden output of the cell.

Peephole structures may provide direct connections from the internal cell state to one or more gates to improve timing accuracy. In the examples where the peephole connections are utilized, the gates (e.g., the forget, input, and output gates) may further receive direct connections from the internal cell state, enabling the forget, input, and output gates to access the magnitude of the cell state when computing gating values. This may improve timing-dependent behaviors, such as detecting precise temporal intervals or slow neural oscillations.

During operation of the LSTM model, each gate (e.g., the forget, input, or output gates) may compute a gating value using a sigmoid activation function σ(·), which maps input values to the range (0,1). For example, the forget gate value f_t may be determined according to Equation 2:

$$f\_t = σ ( W\_f \cdot [ h\_ \{ t - 1 \} , x\_t ] + b\_f + V\_f ⊙ c\_ \{ t - 1 \} ) \qquad Equation 2$$

In Equation 2, h_{t−1} is a previous hidden state, x_t is the current input vector, c_{t−1} is a previous cell state, W_f and b_f are learned parameters, and V_f represents optional peephole weights. Similar structures may be used for the input and output gates.

The LSTM model, when executed over the full input sequence, may update its cell state and hidden state at each time step by invoking the same LSTM cell operations. After the final time step, the model outputs the last hidden state as the LSTM-derived feature vector (e.g., at least one second feature). The network parameters of the LSTM cell and LSTM model may be represented using integer precision (e.g., INT16) for efficient hardware implementation. The model may be implemented in PyTorch using an LSTM cell structure, with a sequence length of approximately two hundred and a hidden dimension of sixty four. During operation, the LSTM model may sequentially process the down-sampled LF brainwave signals and may iteratively update its hidden state and cell state across the sequence. After the final time step, the hidden state may represent a compact neural embedding, referred to herein as a state vector P_LSTM. The state vector may encode a variety of inferred mental or physiological states corresponding to slow neural fluctuations detected within the second processing path.

In some examples, the state vector P_LSTM may include or be mapped to values representing estimated behavioral or cognitive states of the user. For illustration only, the state vector may be defined in Equation 3:

$$PLSTM = \{ focus : 0.7 , fatigue : 0.2 , intent : 0.1 \} \qquad Equation 3$$

In Equation 3, the numerical values may indicate normalized or probability-like measures of the model's inference of user focus, fatigue, and motor or cognitive intent. These values may be generated by applying one or more post-processing operations, such as a fully connected layer, a softmax normalization function, or a sigmoid activation on the LSTM hidden state.

The at least one second vector described above may correspond to PLSTM or may be derived from at least part of PLSTM using projection, dimensionality reduction, or filtering operations. The resulting second vector may then be combined with the output of other processing paths (e.g., the first processing path) to generate the final prediction or control signal.

It should be noted that the CNN and LSTM architectures described above are provided merely as examples, and other architectures may be employed. For instance, the CNN model may include three or more convolutional layers, or additional activation, pooling, or normalization layers. Likewise, the LSTM model may include more or fewer than 64 hidden units, may incorporate multiple stacked layers, or may be configured to process input sequences over different numbers of time steps. The numerical values and model configurations described herein are provided by way of example only, and other architectures or parameter values may be used without departing from the scope of the present disclosure. Accordingly, no limitation is intended with respect to the specific model architecture described herein. In addition, other neural network model(s) may also be implemented to generate first vector and second vector.

In some examples, a feedback-based error monitoring mechanism for adjusting parameters is used to optimize the first processing path and the second processing path. Referring to FIG. 5, at block 518, the command data and the state data are compared periodically, for example, every one hundred milliseconds. At block 520, the computing device may adjust at least one processing parameter in the first processing path and the second processing path based on the comparison.

In some examples, the comparison operation generates a feedback signal based on a similarity metric or an error function value between the first and second feature vectors. In one example, the feedback signal is computed as a cosine similarity value, expressed as:

$$cos ( θ ) = \frac{{\overline{v}}_{CNN} \cdot {\overline{v}}_{LSTM}}{‖ {\overline{v}}_{CNN} ‖ \cdot ‖ {\overline{v}}_{LSTM} ‖} \qquad Equation 4$$

In Equation 4, v̅_{CNN} represents a first feature (e.g., a first vector); and v̅_{LSTM} represents a second feature (e.g., a second vector).

In other examples, the feedback signal is computed as an error function value such as a mean squared error (MSE) as defined in Equation 5.

$$MSE = \frac{1}{n} \sum {( {v}_{CNNi} - {v}_{LSTMi} )}^{2} \qquad Equation 5$$

In some examples, the at least one parameter to be adjusted includes a frequency threshold of the CNN model for selecting the HF components; and gating coefficients of the LSTM model. Based on the feedback signal, the computing device adaptively adjusts parameters (e.g., weights in the neural network models) in both processing paths to minimize discrepancies between the two processing paths in subsequent iterations.

The adjustment may be implemented within an iterative optimization loop. In one example, a parameter update may be expressed as:

$$parameter\_new = parameter\_old + learning\_rate \times ( error\_gradient ) \qquad Equation 6$$

In Equation 6, parameter_old refers to the current value of a trainable parameter within the CNN or LSTM model, such as a frequency threshold, convolutional kernel weight, a recurrent weight matrix value, or a bias term; parameter_new represents an updated value of the same parameter after an optimization step. The learning_rate may correspond to a scalar coefficient that governs the magnitude of the parameter update and may be predetermined, or adjusted based on performance metrics (e.g., confidence scores associated with features). The error gradient may represent the partial derivative of a loss or discrepancy function with respect to the parameter_old, and may be computed using backpropagation or another gradient-based optimization technique.

A threshold-based decision can determine the adjustment of the first and second processing paths. For example, if the cosine similarity falls below a first similarity threshold (a predetermined similarity threshold), or if the error function value exceeds a predetermined value, the computing device adjusts parameters in the two paths to reduce future discrepancies. The numerical threshold values described herein are provided by way of example only, and other threshold values or adaptive thresholding strategies may be used in different implementations.

In the first processing path, when the cosine similarity is smaller than a first similarity threshold, the computing device increases the frequency threshold of the CNN model (e.g., from thirty Hz to fifty Hz) to suppress noisy or false-positive HF components. In this manner, the CNN model is configured to receive and process HF components having higher frequency. Increasing the frequency threshold allows the CNN model to focus on more prominent and reliable signal components, improving the quality of extracted short-term features. Conversely, when the cosine similarity is greater than a second similarity threshold but the error function value has a value greater than a first error threshold, the computing device may decrease the frequency threshold of the CNN model to allow more signal components to pass through, preventing over-filtering that may cause loss of meaningful information.

In some examples, the magnitude threshold used by the CNN model may also be adjusted based on the cosine similarity. For instance, when the cosine similarity is smaller than a third similarity threshold (a predetermined similarity threshold), the computing device may increase the magnitude threshold of the CNN model to suppress low-amplitude noise. In this manner, the CNN model is configured to receive and process input components having higher magnitudes.

In the second processing path, the computing device adjusts parameters based on the same feedback signal. In one example, when the error function value has a value greater than the second error threshold, the computing device may reduce the gating coefficients of the LSTM model, such as the forget gate coefficients, to discard outdated or irrelevant long-term information and place greater emphasis on recent data. This may enable the LSTM model to more quickly adapt to changing signal conditions or intent of the operator.

In some examples, the adjustment of the second processing path (e.g., LSTM model) may involve updating parameters such as the recurrent weight matrices, input and forget gate coefficients, bias terms, or hidden state initialization values, based on the refined first feature received. Similarly, the adjustment of the first processing path (e.g., CNN model) may involve adjusting parameters such as convolutional kernel weights, layer biases, activation thresholds, or magnitude thresholds, based on the refined first feature received. Through this bidirectional feedback and parameter adaptation, the computing device achieves improved consistency and accuracy between the first processing path and the second processing path.

FIG. 6 depicts a flowchart of a method 600 for causing an external device (ED) to perform a sequence of actions based on brainwave signals, arranged in accordance with at least one embodiment described herein. The method 600 may be programmably performed or controlled by a processor, e.g., the computing device 104 or the processor 105 of FIGS. 1 and 3. In an example implementation, the method 600 may be performed in whole or in part by the BCI system 107 of FIGS. 1 and 3. Some embodiments herein may include a non-transitory computer-readable storage medium that includes computer-executable instructions executable by a processor device to perform or control performance of any operations herein, such as the operations of the method 600 of FIG. 6. The method 600 may include one or more of blocks 602, 604, 606, 608, 610, and/or 612.

At block 602, the method 600 may include capturing multi-channel brainwave signals of an operator associated with an external device (ED). For example, block 602 may include the brainwave recorder 102 capturing the brainwave signals (e.g., multi-channel brainwave signals) as described with respect to FIGS. 1 and 3. Block 602 may be followed by block 604.

At block 604, the method 600 may include segmenting the brainwave signals into HF brainwave signals and LF brainwave signals. For example, block 604 may include the processor 105 segmenting the brainwave signals into the HF brainwave signals and the LF brainwave signals as described with respect to FIGS. 1 and 3. Block 604 may be followed by block 606.

At block 606, the method 600 may include generating command data related to control of the external device (ED) based on the HF brainwave signals. For example, block 606 may include the first processing circuit 322 generating the command data based on the HF brainwave signals as described above with respect to FIGS. 1 and 3, Block 606 may be followed by block 608.

At block 608, the method 600 may include generating state data related to a state of the operator based on the LF brainwave signals. For example, block 608 may include the second processing circuit 323 generating the state data based on the LF brainwave signals as described above with respect to FIGS. 1 and 3. Block 608 may be followed by block 610.

At block 610, the method 600 may include generating a command set for the external device (ED) based on the command data and the state data. For example, block 610 may include the processor 105 generating the command set based on the command data and the state data as described above with respect to FIGS. 1 and 3. The command set may include a sequence of actions to be performed by the external device (ED). Block 610 may be followed by block 612.

At block 612, the method 600 may include causing the command set to be transmitted to the external device (ED) to cause the external device (ED) to perform the sequence of actions, at least a portion of which may be executed autonomously. For example, block 610 may include the processor 105 causing the antenna 106 to transmit the command set to the external device (ED) 108 to cause the external device (ED) 108 to perform the sequence of actions, at least a portion of which may be executed autonomously as described above with respect to FIGS. 1 and 3.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, the method 600 may further include processing the HF brainwave signals to extract frequency features; and mapping, using a machine learning model, the frequency features to specific commands for the external device (ED). The command data may be representative of the commands for the external device (ED)

As another example, the method 600 may further include processing the LF brainwave signals to isolate LF components; and estimating, using a machine learning model, the state of the operator based on the LF components, the state data being representative of the estimated state of the operator.

FIG. 7 depicts a flowchart of a method 700 for determining and displaying a synchronization state of a first operator and a second operator, arranged in accordance with at least one embodiment described herein. The method 700 may be programmably performed or controlled by a processor, e.g., the computing device 104 or the processor 105 of FIGS. 2 and 3. In an example implementation, the method 700 may be performed in whole or in part by the BCI system 207 of FIGS. 2 and 3. Some embodiments herein may include a non-transitory computer-readable storage medium that includes computer-executable instructions executable by a processor device to perform or control performance of any operations herein, such as the operations of the method 700 of FIG. 7. The method 700 may include one or more of blocks 702, 704, 706, 708, 710, 712, 714, and/or 716.

At block 702, the method 700 may include capturing multi-channel brainwave signals of a first operator. For example, block 702 may include the first brainwave recorder 202a capturing the brainwave signals (e.g., the multi-channel brainwave signals) of the first operator 201a as described with respect to FIGS. 2 and 3. Block 702 may be followed by block 704.

At block 704, the method 700 may include capturing multi-channel brainwave signals of a second operator. For example, block 704 may include the second brainwave recorder 202b capturing the brainwave signals (e.g., the multi-channel brainwave signals) of the second operator 201b as described with respect to FIGS. 2 and 3. Block 704 may be followed by block 706.

At block 706, the method 700 may include segmenting the brainwave signals of the first operator and the second operator into HF brainwave signals and LF brainwave signals. For example, block 706 may include the processor 105 segmenting the brainwave signals of the first operator 201a and the second operator 201b into the HF brainwave signals and the LF brainwave signals as described above with respect to FIGS. 2 and 3. Block 706 may be followed by block 708.

At block 708, the method 700 may include generating decision data related to the first operator and the second operator based on the HF brainwave signals. For example, block 708 may include the first processing circuit 322 generating the decision data related to the first operator 201a and the second operator 201b based on the HF brainwave signals as described above in relation to FIGS. 2 and 3. Block 708 may be followed by block 710.

At block 710, the method 700 may include generating state data related to states of the first operator and the second operator based on the LF brainwave signals. For example, block 710 may include the second processing circuit 323 generating the state data related to the states of the first operator 201a and the second operator 201b as described above with respect to FIGS. 2 and 3. Block 710 may be followed by block 712.

At block 712, the method 700 may include determining a synchronization state of the first operator and the second operator based on the decision data and the state data. For example, block 712 may include the processor 105 determining the synchronization state of the first operator 201a and the second operator 201b based on the decision data and the state data as described above with respect to FIGS. 2 and 3. The synchronization state may indicate an amount of synchronization between the brainwave signals of the first operator and the second operator. Block 712 may be followed by block 714.

At block 714, the method 700 may include generating synchronization data representative of the synchronization state. For example, block 714 may include the processor 105 generating the synchronization data representative of the synchronization state as described above with respect to FIGS. 2 and 3. Block 714 may be followed by block 716.

At block 716, the method 700 may include causing the synchronization data to be transmitted to user interfaces of the first operator and the second operator such that the synchronization state is displayed to the first operator and the second operator. For example, block 716 may include the processor 105 causing the synchronization data to be transmitted to user interfaces on the user devices 203a-b of the first operator 201a and the second operator 201b such that the synchronization state is displayed as described above with respect to FIGS. 2 and 3.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, the method 700 may further include encoding the synchronization data into packets that include a local component associated with the decision data and a global component associated with the state data.

As another example, the method 700 may further include monitoring the states of the first operator and the second operator over a period of time; and adjusting a signal processing parameter based on the monitored states to synchronize at least one of an amplitude, a phase, or a frequency of the brainwave signals of the first operator and the second operator.

As yet another example, the method 700 may further include processing the brainwave signals of the first operator and the second operator to extract HF features and LF features; processing the HF features; mapping, using a machine learning model, the HF features to specific commands or decisions of the first operator or the second operator, the decision data being representative of the commands or decisions of the first operator or the second operator; processing the LF features; and estimating, using a machine learning model, the state of the first operator and the second operator based on the LF features, the state data being representative of the estimated state of the first operator and the second operator.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The subject technology of the present disclosure is illustrated, for example, according to various aspects described below. Various examples of aspects of the present disclosure are described as numbered examples (1, 2, 3, etc.) for convenience. These are provided as examples and do not limit the present disclosure. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A system including:
a brainwave recorder configured to capture multi-channel brainwave signals of an operator associated with an external device (ED);
a processor configured to:
   segment the brainwave signals into high-frequency brainwave signals and low-frequency brainwave signals, the processor including a dual-path processing arrangement including:
      a first processing path configured to generate command data related to control of the external device (ED) based on the high-frequency brainwave signals; and
      a second processing path configured to generate state data related to a state of the operator based on the low-frequency brainwave signals;
   generate a command set for the external device (ED) based on the command data and the state data, the command set including a sequence of actions to be performed by the external device (ED); and
   cause the command set to be transmitted to the external device (ED) to cause the external device (ED) to perform the sequence of actions, at least a portion of which may be executed autonomously.

Example 2. The system of example 1, wherein the first processing path is configured to:
process the high-frequency brainwave signals to extract frequency features; and
map, using a machine learning model, the frequency features to specific commands for the external device (ED), the command data being representative of the commands for the external device (ED).

Example 3. The system of any example herein, particular of example 1, wherein the machine learning model comprises at least one of a convolutional neural network, a recurrent neural network, a long short-term memory network, or a combination thereof, having a configurable number of layers or parameters.

Example 4. The system of any example herein, particularly of example 1, wherein the second processing path is configured to:
process the low-frequency brainwave signals to isolate low-frequency components; and
estimate, using a machine learning model, the state of the operator based on the low-frequency components, the state data being representative of the estimated state of the operator.

Example 5. The system of any example herein, particularly of example 1, wherein the processor is configured to:
compare the command data with the state of the operator indicated in the state data; and
revise the command data based on the comparison.

Example 6. The system of any example herein, particularly of example 1, wherein the processor is configured to:
compare the command data with the state data; and
adjust a signal processing parameter of at least one of the first processing path or the second processing path based on the comparison.

Example 7. The system of any example herein, particular of example 1, wherein a boundary frequency separating the high-frequency brainwave signals and the low-frequency brainwave signals is configurable or dynamically adjustable based on at least one of a sensing modality, a noise condition, an operator characteristic, or an operational context.

Example 8. The system of any example herein, particular of example 1, wherein the brainwave recorder comprises at least one of:
(a) a non-invasive neural sensor configured to capture oscillatory brainwave activity; or
(b) an invasive or semi-invasive neural interface configured to capture spike-related activity or local field potentials.

Example 9. The system of any example herein, particular of example 1, wherein the processor is further configured to compare the command data and the state data and to adaptively modify at least one signal processing parameter of the first processing path or the second processing path based on the comparison.

Example 10. The system of example 9, wherein the at least one signal processing parameter comprises at least one of a frequency threshold, a confidence threshold, a gating coefficient, a model weight, or a fusion weight.

Example 11. The system of example 9, wherein the adaptive modification is triggered when a similarity metric or an error metric between the command data and the state data crosses a predetermined threshold.

Example 12. A method including:
capturing multi-channel brainwave signals of an operator associated with an external device (ED);
segmenting the brainwave signals into high-frequency brainwave signals and low-frequency brainwave signals;
generating command data related to control of the external device (ED) based on the high-frequency brainwave signals; and
generating state data related to a state of the operator based on the low-frequency brainwave signals;
generating a command set for the external device (ED) based on the command data and the state data, the command set including a sequence of actions to be performed by the external device (ED); and
causing the command set to be transmitted to the external device (ED) to cause the external device (ED) to perform the sequence of actions, at least a portion of which may be executed autonomously.

Example 13. The method of example 6 including:
processing the high-frequency brainwave signals to extract frequency features; and
mapping, using a machine learning model, the frequency features to specific commands for the external device (ED), the command data being representative of the commands for the external device (ED).

Example 14. The method of any example herein, particularly of example 6, including:
processing the low-frequency brainwave signals to isolate low-frequency components; and
estimating, using a machine learning model, the state of the operator based on the low-frequency components, the state data being representative of the estimated state of the operator.

Example 15. The method of example 12, wherein segmenting the brainwave signals comprises selecting a boundary frequency between high-frequency and low-frequency components from a configurable range.

Example 16. The method of any example herein, particularly of example 12, wherein generating the command data is based on oscillatory neural activity in non-invasive embodiments and is based on spike-related activity or local field potentials in invasive or semi-invasive embodiments.

Example 17. The method of any example herein, particularly of example 12, further comprising adaptively adjusting at least one signal processing parameter of high-frequency processing or low-frequency processing based on a comparison between the command data and the state data.

Example 18. The method of example 17, wherein the adaptive adjustment is performed when a similarity metric between features derived from the high-frequency signals and the low-frequency signals crosses a predetermined threshold.

Example 19. A system including:
a first brainwave recorder configured to capture multi-channel brainwave signals of a first operator;
a second brainwave recorder configured to capture multi-channel brainwave signals of a second operator;
a processor configured to:
   segment the brainwave signals of the first operator and the second operator into high-frequency brainwave signals and low-frequency brainwave signals, the processor including a dual-path processing arrangement including:
      a first processing path configured to generate decision data related to the first operator and the second operator based on the high-frequency brainwave signals; and
      a second processing path configured to generate state data related to states of the first operator and the second operator based on the low-frequency brainwave signals;
   determine a synchronization state of the first operator and the second operator based on the decision data and the state data, wherein the synchronization state indicates an amount of synchronization between the brainwave signals of the first operator and the second operator;
   generate synchronization data representative of the synchronization state; and
   cause the synchronization data to be transmitted to user interfaces of the first operator and the second operator such that the synchronization state is displayed to the first operator and the second operator.

Example 20. The system of example 19, wherein the synchronization state indicates commands or decisions made by the first operator or the second operator.

Example 21. The system of any example herein, particularly of example 19, wherein the processor is configured to encode the synchronization data into packets that include a local component associated with the decision data and a global component associated with the state data.

Example 22. The system of any example herein, particularly of example 19, wherein the processor is configured to:
monitor the states of the first operator and the second operator over a period of time; and
adjust a signal processing parameter of at least one of the first processing path or the second processing path based on the monitored states to synchronize at least one of an amplitude, a phase, or a frequency of the brainwave signals of the first operator and the second operator.

Example 23. The system of any example herein, particularly of example 19, wherein the processor is configured to align at least one of a phase, a frequency, or an amplitude of the brainwave signals of the first operator and the second operator.

Example 24. The system of any example herein, particularly of example 19, wherein:
the first operator and the second operator are located remotely to each other; and
the processor includes a distributed processor including a cloud-based processor connected to the first brainwave recorder and the second brainwave recorder via a network.

Example 25. The system of any example herein, particularly of example 19, wherein:
the first operator and the second operator are co-located; and
the processor includes a local server connected to the first brainwave recorder and the second brainwave recorder via a network.

Example 26. The system of any example herein, particularly of example 19, wherein:
the processor is configured to process the brainwave signals of the first operator and the second operator to extract high-frequency features and low-frequency features;
the first processing path is configured to:
   process the high-frequency features; and
   map, using a machine learning model, the high-frequency features to specific commands or decisions of the first operator or the second operator, the decision data being representative of the commands or decisions of the first operator or the second operator;
the second processing path is configured to:
   process the low-frequency features; and
   estimate, using a machine learning model, the state of the first operator and the second operator based on the low-frequency features, the state data being representative of the estimated state of the first operator and the second operator.

Example 27. The system of example 19, wherein the processor is configured to apply different transmission priorities or security policies to decision data derived from the high-frequency brainwave signals and state data derived from the low-frequency brainwave signals.

Example 28. The system of example 27, wherein the decision data is transmitted with lower latency requirements and the state data is transmitted with higher security or integrity requirements.

Example 29. A method including:
capturing multi-channel brainwave signals of a first operator;
capturing multi-channel brainwave signals of a second operator;
segmenting the brainwave signals of the first operator and the second operator into high-frequency brainwave signals and low-frequency brainwave signals;
generating decision data related to the first operator and the second operator based on the high-frequency brainwave signals;
generating state data related to states of the first operator and the second operator based on the low-frequency brainwave signals;
determining a synchronization state of the first operator and the second operator based on the decision data and the state data, wherein the synchronization state indicates an amount of synchronization between the brainwave signals of the first operator and the second operator;
generating synchronization data representative of the synchronization state; and
causing the synchronization data to be transmitted to user interfaces of the first operator and the second operator such that the synchronization state is displayed to the first operator and the second operator.

Example 30. The method of example 29 including encoding the synchronization data into packets that include a local component associated with the decision data and a global component associated with the state data.

Example 31. The method of any example herein, particularly of example 29, including:
monitoring the states of the first operator and the second operator over a period of time; and
adjusting a signal processing parameter based on the monitored states to synchronize at least one of an amplitude, a phase, or a frequency of the brainwave signals of the first operator and the second operator.

Example 32. The method of any example herein, particularly of example 29, including:
processing the brainwave signals of the first operator and the second operator to extract high-frequency features and low-frequency features;
processing the high-frequency features;
mapping, using a machine learning model, the high-frequency features to specific commands or decisions of the first operator or the second operator, the decision data being representative of the commands or decisions of the first operator or the second operator;
processing the low-frequency features; and
estimating, using a machine learning model, the state of the first operator and the second operator based on the low-frequency features, the state data being representative of the estimated state of the first operator and the second operator.

Example 33. The method of example 29, further comprising monitoring synchronization metrics over time and adaptively adjusting at least one signal processing parameter to improve alignment of at least one of an amplitude, a phase, or a frequency of the brainwave signals of the first operator and the second operator.

1. A system comprising:
a brainwave recorder configured to capture multi-channel brainwave signals of an operator associated with an external device (ED);
a processor configured to:
segment the brainwave signals into high-frequency brainwave signals and low-frequency brainwave signals, the processor comprising a dual-path processing arrangement comprising:
a first processing path configured to generate command data related to control of the external device (ED) based on the high-frequency brainwave signals; and
a second processing path configured to generate state data related to a state of the operator based on the low-frequency brainwave signals;
generate a command set for the external device (ED) based on the command data and the state data, the command set comprising a sequence of actions to be performed by the external device (ED); and
cause the command set to be transmitted to the external device (ED) to cause the external device (ED) to perform the sequence of actions, at least a portion of which are executed autonomously.

2. The system of claim 1, wherein the first processing path is configured to:
process the high-frequency brainwave signals to extract frequency features; and
map, using a machine learning model, the frequency features to specific commands for the external device (ED), the command data being representative of the commands for the external device (ED).

3. (canceled)

4. The system of claim 1, wherein the second processing path is configured to:
process the low-frequency brainwave signals to isolate low-frequency components; and
estimate, using a machine learning model, the state of the operator based on the low-frequency components, the state data being representative of the estimated state of the operator.

5. The system of claim 1, wherein the processor is configured to:
compare the command data with the state of the operator indicated in the state data; and
revise the command data based on the comparison.

6. The system of claim 1, wherein the processor is configured to:
compare the command data with the state data; and
adjust a signal processing parameter of at least one of the first processing path or the second processing path based on the comparison.

7. The system of claim 1, wherein a boundary frequency separating the high-frequency brainwave signals and the low-frequency brainwave signals is configurable or dynamically adjustable based on at least one of a sensing modality, a noise condition, an operator characteristic, or an operational context.

8. The system of claim 1, wherein the brainwave recorder comprises at least one of:
(a) a non-invasive neural sensor configured to capture oscillatory brainwave activity; or
(b) an invasive or semi-invasive neural interface configured to capture spike-related activity or local field potentials.

9. The system of claim 1, wherein the processor is further configured to compare the command data and the state data and to adaptively modify at least one signal processing parameter of the first processing path or the second processing path based on the comparison.

10. The system of claim 9, wherein the at least one signal processing parameter comprises at least one of a frequency threshold, a confidence threshold, a gating coefficient, a model weight, or a fusion weight.

11. The system of claim 9, wherein the adaptive modification is triggered when a similarity metric or an error metric between the command data and the state data crosses a predetermined threshold.

12. A method comprising:
capturing multi-channel brainwave signals of an operator associated with an external device (ED);
segmenting the brainwave signals into high-frequency brainwave signals and low-frequency brainwave signals;
generating command data related to control of the external device (ED) based on the high-frequency brainwave signals;
generating state data related to a state of the operator based on the low-frequency brainwave signals;
generating a command set for the external device (ED) based on the command data and the state data, the command set comprising a sequence of actions to be performed by the external device (ED); and
causing the command set to be transmitted to the external device (ED) to cause the external device (ED) to perform the sequence of actions, at least a portion of which are executed autonomously.

13. The method of claim 12 comprising:
processing the high-frequency brainwave signals to extract frequency features; and
mapping, using a machine learning model, the frequency features to specific commands for the external device (ED), the command data being representative of the commands for the external device (ED).

14. The method of claim 12 comprising:
processing the low-frequency brainwave signals to isolate low-frequency components; and
estimating, using a machine learning model, the state of the operator based on the low-frequency components, the state data being representative of the estimated state of the operator.

15. The method of claim 12, wherein segmenting the brainwave signals comprises selecting a boundary frequency between high-frequency and low-frequency components from a configurable range.

16. The method of claim 12, wherein generating the command data is based on oscillatory neural activity in non-invasive embodiments and is based on spike-related activity or local field potentials in invasive or semi-invasive embodiments.

17. The method of claim 12, further comprising adaptively adjusting at least one signal processing parameter of high-frequency processing or low-frequency processing based on a comparison between the command data and the state data.

18. (canceled)

19. A system comprising:
a first brainwave recorder configured to capture multi-channel brainwave signals of a first operator;
a second brainwave recorder configured to capture multi-channel brainwave signals of a second operator;
a processor configured to:
segment the brainwave signals of the first operator and the second operator into high-frequency brainwave signals and low-frequency brainwave signals, the processor comprising a dual-path processing arrangement comprising:
a first processing path configured to generate decision data related to the first operator and the second operator based on the high-frequency brainwave signals; and
a second processing path configured to generate state data related to states of the first operator and the second operator based on the low-frequency brainwave signals;
determine a synchronization state of the first operator and the second operator based on the decision data and the state data, wherein the synchronization state indicates an amount of synchronization between the brainwave signals of the first operator and the second operator;
generate synchronization data representative of the synchronization state; and
cause the synchronization data to be transmitted to user interfaces of the first operator and the second operator such that the synchronization state is displayed to the first operator and the second operator.

20. The system of claim 19, wherein the synchronization state indicates commands or decisions made by the first operator or the second operator.

21. The system of claim 19, wherein the processor is configured to encode the synchronization data into packets that comprise a local component associated with the decision data and a global component associated with the state data.

22. The system of claim 19, wherein the processor is configured to:
monitor the states of the first operator and the second operator over a period of time; and
adjust a signal processing parameter of at least one of the first processing path or the second processing path based on the monitored states to synchronize at least one of an amplitude, a phase, or a frequency of the brainwave signals of the first operator and the second operator.

23. The system of claim 19, wherein the processor is configured to align at least one of a phase, a frequency, or an amplitude of the brainwave signals of the first operator and the second operator.

24. The system of claim 19, wherein:
the first operator and the second operator are located remotely to each other; and
the processor comprises a distributed processor comprising a cloud-based processor connected to the first brainwave recorder and the second brainwave recorder via a network.

25. (canceled)

26. The system of claim 19, wherein:
the processor is configured to process the brainwave signals of the first operator and the second operator to extract high-frequency features and low-frequency features;
the first processing path is configured to:
process the high-frequency features; and
map, using a machine learning model, the high-frequency features to specific commands or decisions of the first operator or the second operator, the decision data being representative of the commands or decisions of the first operator or the second operator;
the second processing path is configured to:
process the low-frequency features; and
estimate, using a machine learning model, the state of the first operator and the second operator based on the low-frequency features, the state data being representative of the estimated state of the first operator and the second operator.

27. The system of claim 19, wherein the processor is configured to apply different transmission priorities or security policies to decision data derived from the high-frequency brainwave signals and state data derived from the low-frequency brainwave signals.

28. (canceled)

29. A method comprising:
capturing multi-channel brainwave signals of a first operator;
capturing multi-channel brainwave signals of a second operator;
segmenting the brainwave signals of the first operator and the second operator into high-frequency brainwave signals and low-frequency brainwave signals;
generating decision data related to the first operator and the second operator based on the high-frequency brainwave signals;
generating state data related to states of the first operator and the second operator based on the low-frequency brainwave signals;
determining a synchronization state of the first operator and the second operator based on the decision data and the state data, wherein the synchronization state indicates an amount of synchronization between the brainwave signals of the first operator and the second operator;
generating synchronization data representative of the synchronization state; and
causing the synchronization data to be transmitted to user interfaces of the first operator and the second operator such that the synchronization state is displayed to the first operator and the second operator.

30. The method of claim 29 comprising encoding the synchronization data into packets that comprise a local component associated with the decision data and a global component associated with the state data.

31. The method of claim 29 comprising:
monitoring the states of the first operator and the second operator over a period of time; and
adjusting a signal processing parameter based on the monitored states to synchronize at least one of an amplitude, a phase, or a frequency of the brainwave signals of the first operator and the second operator.

32. The method of claim 29, comprising:
processing the brainwave signals of the first operator and the second operator to extract high-frequency features and low-frequency features;
processing the high-frequency features;
mapping, using a machine learning model, the high-frequency features to specific commands or decisions of the first operator or the second operator, the decision data being representative of the commands or decisions of the first operator or the second operator;
processing the low-frequency features; and
estimating, using a machine learning model, the state of the first operator and the second operator based on the low-frequency features, the state data being representative of the estimated state of the first operator and the second operator.

33. The method of claim 29, further comprising monitoring synchronization metrics over time and adaptively adjusting at least one signal processing parameter to improve alignment of at least one of an amplitude, a phase, or a frequency of the brainwave signals of the first operator and the second operator.
